(19) United States
(12) Patent Application Publication
(10) Pub. No.: US 2013/0331492 A1
(43) Pub. Date: Dec. 12, 2013

(54) FLAME RETARDANT THERMOPLASTIC COMPOSITIONS, METHODS OF MANUFACTURE THEREOF AND ARTICLES COMPRISING THE SAME

(71) Applicant: SABIC Innovative Plastics IP B.V., Bergen op Zoom (NL)

(72) Inventor: Kirti Sharma, Bergen op Zoom (NL)

(73) Assignee: SABIC INNOVATIVE PLASTICS IP B.V., Bergen op Zoom (NL)

(21) Appl. No.: 13/902,671

(22) Filed: May 24, 2013

Related U.S. Application Data
(60) Provisional application No. 61/651,487, filed on May 24, 2012.
(60) Provisional application No. 61/748,795, filed on Jan. 4, 2013.

(51) Int. Cl. C08L 83/04

(52) U.S. Cl. CPC C08L 83/04
USPC 524/116; 524/122

(57) ABSTRACT

Disclosed herein too is a flame retardant composition comprising a polyphenylene ether, a polyphenylene ether-polysiloxane copolymer, or a combination comprising at least one of the foregoing polymers; an impact modifier; and a phosphazene compound. Disclosed herein too is a method comprising blending a polyphenylene ether, a polyphenylene ether-polysiloxane copolymer, or a combination comprising at least one of the foregoing polymers; an impact modifier; and a phosphazene compound.

### CROSS-REFERENCE TO RELATED APPLICATIONS

This application claims priority to U.S. Provisional Application No. 61/651,487 filed on May 24, 2012, and to U.S. Provisional Application No. 61/748,795 filed on Jan. 4, 2013, the entire contents of which are hereby incorporated by reference.

### BACKGROUND

This disclosure relates to flame retardant thermoplastic compositions, methods of manufacture thereof and to articles comprising the same. In particular, this disclosure relates to flame retardant polyesters and to flame retardant polyester blends. In particular too, this disclosure relates to flame retardant polyphenylene ethers and to flame retardant polyphenylene ether blends.

In electronic and electrical devices such as notebook personal computers, e-books, and tablet personal computers, metallic body panels are being replaced by materials that are lighter in weight and offer a robust combination of mechanical properties. These lighter materials result in weight savings, cost savings and enable the manufacture of complex designs. While these lighter materials can be used to manufacture panels having thinner cross-sectional thicknesses, it is desirable to improve the stiffness of the material to prevent warping, while at the same time improve the impact resistance. It is also desirable to improve the flame retardancy of the material to reduce fire related hazards.

### SUMMARY

Disclosed herein too is a flame retardant composition comprising a polyphenylene ether-polysiloxane copolymer, or a combination comprising polyphenylene ether-polysiloxane copolymer and a polyphenylene ether homopolymer; an impact modifier; and a phosphazene compound.

Disclosed herein too is a method comprising blending a polyphenylene ether-polysiloxane copolymer, or a combination comprising polyphenylene ether-polysiloxane copolymer and a polyphenylene ether homopolymer; an impact modifier; and a phosphazene compound to form a flame retardant composition.

### BRIEF DESCRIPTION OF FIGURES

FIG. 1 depicts a series of micrographs at different magnifications that show the dispersion of phosphazene compound in the polyphenylene ether;

FIG. 2 is a bar graph showing melt viscosity rate (MVR) data for the flame retardant compositions containing polyphenylene ether-polysiloxane copolymers, polystyrene and the phenoxyphosphazene compound;

FIG. 3 is a bar graph showing melt viscosity (MV) data for the flame retardant compositions containing polyphenylene ether-polysiloxane copolymers, polystyrene and the phenoxyphosphazene compound;

FIG. 4 is a bar graph showing notched Izod data, Charpy impact data and multi-axial impact data for the flame retardant compositions containing polyphenylene ether-polysiloxane copolymers, polystyrene and the phenoxyphosphazene compound;

FIG. 5 is a bar graph showing nominal strain at break data for the flame retardant compositions containing polyphenylene ether-polysiloxane copolymers, polystyrene and the phenoxyphosphazene compound; and

FIG. 6 is a bar graph showing heat distortion temperature and Vicat temperature for compositions containing polyphenylene ether-polysiloxane copolymers, polystyrene and the phenoxyphosphazene compound; and

FIG. 7 is a graph that shows that compositions that contain 30 wt % of the phenoxyphosphazene compound display the same flame retardancy as comparative compositions.

### DETAILED DESCRIPTION

As used herein the singular forms “a,” “an,” and “the” include plural referents. The term “combination” is inclusive of blends, mixtures, alloys, reaction products, and the like. Unless defined otherwise, technical and scientific terms used herein have the same meaning as is commonly understood by one of skill. Compounds are described using standard nomenclature. The term “and a combination thereof” is inclusive of the named component and/or other components not specifically named that have essentially the same function.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. The endpoints of all ranges reciting the same characteristic or component are independently combinable and inclusive of the recited endpoint. Unless expressly indicated otherwise, the various numerical ranges specified in this application are approximations. The term “from more than 0 to” an amount means that the named component is present in some amount more than 0, and up to and including the higher named amount.

The transition term “comprising” is inclusive of the transition terms “consisting of” and “consisting essentially of” The term “and/or” is used herein to mean both “and” as well as “or”. For example, “A and/or B” is construed to mean A, B or A and B.

All ASTM tests and data are from the 2003 edition of the Annual Book of ASTM Standards unless otherwise indicated. All cited references are incorporated herein by reference. For the sake of clarity, the terms “terephthalic acid group,” “isophthalic acid group,” “butanediol group,” and “ethylene glycol group” have the following meanings. The term “terephthalic acid group” in a composition refers to a divalent 1,4-benzene radical (-1,4-(C₆H₄)—) remaining after removal of the carboxylic groups from terephthalic acid-. The term “isophthalic acid group” refers to a divalent 1,3-benzene radical (-(-1,3-C₆H₄)—) remaining after removal of the carboxylic groups from isophthalic acid. The “butanediol group” refers to a divalent butylene radical (—(C₄H₈)—) remaining after removal of hydroxyl groups from butanediol. The term “ethylene glycol group” refers to a divalent ethylene radical (—(C₂H₄)—) remaining after removal of hydroxyl groups from ethylene glycol. With respect to the terms “terephthalic acid group,” “isophthalic acid group,” “ethylene glycol group,” “butane diol group,” and “diethylene glycol group” being used in other contexts, e.g., to indicate the weight % of the group in a composition, the term “isophthalic acid group(s)” means the group having the formula (—O(CO)C₆H₄(CO)—), the term “terephthalic acid group” means the group having the formula (—O(CO)C₆H₄(CO)—), the term diethylene glycol group means the group having the formula (—O(C₂H₄)O(C₂H₄)—), the term “butanediol group” means the group having the formula (—O(C₄H₈)—), and the term “ethylene glycol groups” means the group having formula (—O(C₂H₄)—).

Disclosed herein is another flame retardant composition that comprises a polyphenylene ether and/or a polyphenylene ether blend and a phenoxyphosphazene compound compound. The polyphenylene ether blends comprise polyamides, polystyrenes and/or polyphenylene ether sulfide. This flame retardant composition also displays a suitable combination of stiffness and ductility as well as a low melt viscosity that renders it easily processable. The flame retardant composition can be used in electronics goods such as notebook personal computers, e-books, tablet personal computers, and the like.

In an embodiment, the flame retardant composition comprises a poly(phenylene ether). Suitable poly(phenylene ether)s include those comprising repeating structural units having the formula (1)

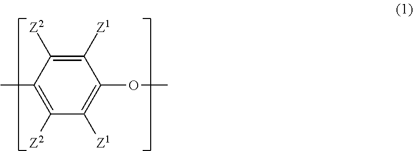

wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. As one example, Z¹ can be a di-n-butylaminomethyl group formed by reaction of a terminal 3,5-dimethyl-1,4-phenyl group with the di-n-butylamine component of an oxidative polymerization catalyst.

In some embodiments, the poly(phenylene ether) has an intrinsic viscosity of about 0.25 to about 1 deciliter per gram measured at 25° C. in chloroform. Within this range, the poly(phenylene ether) intrinsic viscosity can be about 0.3 to about 0.65 deciliter per gram, more specifically about 0.35 to about 0.5 deciliter per gram, even more specifically about 0.4 to about 0.5 deciliter per gram.

In some embodiments, the poly(phenylene ether) is a poly(2,6-dimethyl-1,4-phenylene ether) prepared with a morpholine-containing catalyst, wherein a purified sample of poly(2,6-dimethyl-1,4-phenylene ether) prepared by dissolution of the poly(2,6-dimethyl-1,4-phenylene ether) in toluene, precipitation from methanol, reslurry, and isolation has a monomodal molecular weight distribution in the molecular weight range of 250 to 1,000,000 atomic mass units, and comprises less than or equal to 2.2 weight percent of poly(2,6-dimethyl-1,4-phenylene ether) having a molecular weight more than fifteen times the number average molecular weight of the entire purified sample. In some embodiments, the purified sample after separation into six equal poly(2,6-dimethyl-1,4-phenylene ether) weight fractions of decreasing molecular weight comprises a first, highest molecular weight fraction comprising at least 10 mole percent of poly(2,6-dimethyl-1,4-phenylene ether) comprising a terminal morpholine-substituted phenoxy group. The poly(2,6-dimethyl-1,4-phenylene ether) according to these embodiments is further described in U.S. Patent Application Publication No. 2011/0003962 A1 of Carrillo et al.

In some embodiments, the poly(phenylene ether) is essentially free of incorporated diphenoquinone residues. In the context, “essentially free” means that the fewer than 1 weight percent of poly(phenylene ether) molecules comprise the residue of a diphenoquinone. As described in U.S. Pat. No. 3,306,874 to Hay, synthesis of poly(phenylene ether) by oxidative polymerization of monohydric phenol yields not only the desired poly(phenylene ether) but also a diphenoquinone as side product. For example, when the monohydric phenol is 2,6-dimethylphenol, 3,3′,5,5′-tetramethyldiphenoquinone is generated. Typically, the diphenoquinone is “reequilibrated” into the poly(phenylene ether) (i.e., the diphenoquinone is incorporated into the poly(phenylene ether) structure) by heating the polymerization reaction mixture to yield a poly(phenylene ether) comprising terminal or internal diphenoquinone residues). For example, when a poly(phenylene ether) is prepared by oxidative polymerization of 2,6-dimethylphenol to yield poly(2,6-dimethyl-1,4-phenylene ether) and 3,3′,5,5′-tetramethyldiphenoquinone, reequilibration of the reaction mixture can produce a poly(phenylene ether) with terminal and internal residues of incorporated diphenoquinone.

However, such reequilibration reduces the molecular weight of the poly(phenylene ether). Accordingly, when a higher molecular weight poly(phenylene ether) is desired, it may be desirable to separate the diphenoquinone from the poly(phenylene ether) rather than reequilibrating the diphenoquinone into the poly(phenylene ether) chains. Such a separation can be achieved, for example, by precipitation of the poly(phenylene ether) in a solvent or solvent mixture in which the poly(phenylene ether) is insoluble and the diphenoquinone is soluble. For example, when a poly(phenylene ether) is prepared by oxidative polymerization of 2,6-dimethylphenol in toluene to yield a toluene solution comprising poly(2,6-dimethyl-1,4-phenylene ether) and 3,3′,5,5′-tetramethyldiphenoquinone, a poly(2,6-dimethyl-1,4-phenylene ether) essentially free of diphenoquinone can be obtained by mixing 1 volume of the toluene solution with about 1 to about 4 volumes of methanol or a methanol/water mixture.

Alternatively, the amount of diphenoquinone side-product generated during oxidative polymerization can be minimized (e.g., by initiating oxidative polymerization in the presence of less than 10 weight percent of the monohydric phenol and adding at least 95 weight percent of the monohydric phenol over the course of at least 50 minutes), and/or the reequilibration of the diphenoquinone into the poly(phenylene ether) chain can be minimized (e.g., by isolating the poly(phenylene ether) no more than 200 minutes after termination of oxidative polymerization). These approaches are described in U.S. Patent Application Publication No. US 2009/0211967 A1 of Delsman et al. In an alternative approach utilizing the temperature-dependent solubility of diphenoquinone in toluene, a toluene solution containing diphenoquinone and poly(phenylene ether) can be adjusted to a temperature of about 25° C., at which diphenoquinone is poorly soluble but the poly(phenylene ether) is soluble, and the insoluble diphenoquinone can be removed by solid-liquid separation (e.g., filtration).

In some embodiments, the poly(phenylene ether) comprises 2,6-dimethyl-1,4-phenylene ether units, 2,3,6-trimethyl-1,4-phenylene ether units, or a combination thereof. In some embodiments, the poly(phenylene ether) is a poly(2,6-dimethyl-1,4-phenylene ether). In some embodiments, the poly(phenylene ether) comprises a poly(2,6-dimethyl-1,4-phenylene ether) having an intrinsic viscosity of about 0.35 to about 0.5 deciliter per gram, specifically about 0.35 to about 0.46 deciliter per gram, measured at 25° C. in chloroform.

The poly(phenylene ether) can comprise molecules having aminoalkyl-containing end group(s), typically located in a position ortho to the hydroxy group. Also frequently present are tetramethyldiphenoquinone (TMDQ) end groups, typically obtained from 2,6-dimethylphenol-containing reaction mixtures in which tetramethyldiphenoquinone by-product is present. The poly(phenylene ether) can be in the form of a homopolymer, a copolymer, a graft copolymer, an ionomer, or a block copolymer, as well as combinations thereof.

The flame retardant composition comprises the poly(phenylene ether) in an amount of about 5 to about 90 weight percent, based on the total weight of the flame retardant composition. Within this range, the poly(phenylene ether) amount can be about 10 to about 85 weight percent, more specifically about 30 to about 80 weight percent, based on the total weight of the flame retardant composition.

The flame retardant compositions may also comprise a poly(phenylene ether)-polysiloxane block copolymer reaction product which in turn comprises a poly(phenylene ether)-polysiloxane block copolymer and a poly(phenylene ether) homopolymer.

The flame retardant composition may therefore contain a polyphenylene ether, a poly(phenylene ether)-polysiloxane copolymer, or a combination of polyphenylene ether and the poly(phenylene ether)-polysiloxane copolymer.

For brevity, the poly(phenylene ether)-polysiloxane block copolymer reaction product is sometimes referred to herein as the “reaction product”. The poly(phenylene ether)-polysiloxane block copolymer reaction product is synthesized by oxidative polymerization of a mixture of monohydric phenol and hydroxyaryl-terminated polysiloxane. This oxidative polymerization produces poly(phenylene ether)-polysiloxane block copolymer as the desired product and poly(phenylene ether) homopolymer as a by-product. The poly(phenylene ether)-polysiloxane block copolymer is therefore incorporated into the flame retardant composition as a “poly(phenylene ether)-polysiloxane block copolymer reaction product” that comprises both the poly(phenylene ether) homopolymer and the poly(phenylene ether)-polysiloxane block copolymer.

The poly(phenylene ether)-polysiloxane block copolymer comprises a poly(phenylene ether) block and a polysiloxane block. The poly(phenylene ether) block is a residue of the polymerization of the monohydric phenol. In some embodiments, the poly(phenylene ether) block comprises phenylene ether repeating units having the structure detailed above in the formula (1) and the associated description.

The polysiloxane block is a residue of the hydroxyaryl-terminated polysiloxane. In some embodiments, the polysiloxane block comprises repeating units having the structure in formula (2)

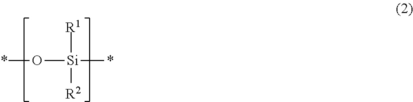

wherein each occurrence of R¹ and R² is independently hydrogen, C₁-C₁₂ hydrocarbyl or C₁-C₁₂ halohydrocarbyl; and the polysiloxane block further comprises a terminal unit having the structure of formula (3)

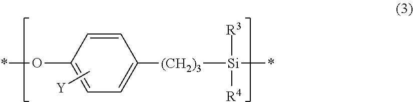

wherein Y is hydrogen, C₁-C₁₂ hydrocarbyl, C₁-C₁₂ hydrocarbyloxy, or halogen, and wherein each occurrence of R³ and R⁴ is independently hydrogen, C₁-C₁₂ hydrocarbyl or C₁-C₁₂ halohydrocarbyl. In some embodiments, the polysiloxane repeating units comprise dimethylsiloxane (—Si(CH₃)₂O—) units. In some embodiments, the polysiloxane block has the structure of formula (4)

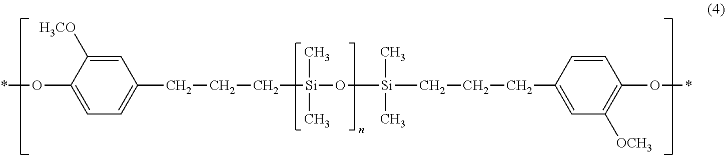

wherein n is, on average, about 20 to about 60.

The hydroxyaryl-terminated polysiloxane comprises at least one hydroxyaryl terminal group. In some embodiments, the hydroxyaryl-terminated polysiloxane has a single hydroxyaryl terminal group, in which case a poly(phenylene ether)-polysiloxane diblock copolymer is formed. In other embodiments, the hydroxyaryl-terminated polysiloxane has two hydroxyaryl terminal groups, in which case poly(phenylene ether)-polysiloxane diblock copolymer and/or poly(phenylene ether)-polysiloxane-poly(phenylene ether) triblock copolymer are formed. It is also possible for the hydroxyaryl-terminated polysiloxane to have a branched structure that allows three or more hydroxyaryl terminal groups and the formation of corresponding branched block copolymers.

In some embodiments, the hydroxyaryl-terminated polysiloxane comprises, on average, about 20 to about 80 siloxane repeating units, specifically about 25 to about 70 siloxane repeating units, more specifically about 30 to about 60 siloxane repeating units, still more specifically about 35 to about 50 siloxane repeating units, yet more specifically about 40 to about 50 siloxane repeating units. The number of siloxane repeating units in the polysiloxane block is essentially unaffected by the copolymerization and isolation conditions, and it is therefore equivalent to the number of siloxane repeating units in the hydroxyaryl-terminated polysiloxane starting material. When not otherwise known, the average number of siloxane repeating units per hydroxylaryl-terminated polysiloxane molecule can be determined by nuclear magnetic resonance (NMR) methods that compare the intensities of signals associated with the siloxane repeating units to those associated with the hydroxyaryl terminal groups. For example, when the hydroxyaryl-terminated polysiloxane is a eugenol-capped polydimethylsiloxane, it is possible to determine the average number of siloxane repeating units by a proton nuclear magnetic resonance (¹H NMR) method in which integrals for the protons of the dimethylsiloxane resonance and the protons of the eugenol methoxy group are compared.

In some embodiments, the poly(phenylene ether)-polysiloxane block copolymer reaction product has a weight average molecular weight of at least 30,000 atomic mass units. For example, the reaction product can have a weight average molecular weight of 30,000 to about 150,000 atomic mass units, specifically about 35,000 to about 120,000 atomic mass units, more specifically about 40,000 to about 90,000 atomic mass units, even more specifically about 45,000 to about 70,000 atomic mass units. In some embodiments, the poly(phenylene ether)-polysiloxane block copolymer reaction product has a number average molecular weight of about 10,000 to about 50,000 atomic mass units, specifically about 10,000 to about 30,000 atomic mass units, more specifically about 14,000 to about 24,000 atomic mass units.

In some embodiments, the poly(phenylene ether)-polysiloxane block copolymer reaction product has an intrinsic viscosity of at least 0.3 deciliter per gram, as measured by Ubbelohde viscometer at 25° C. in chloroform. In some embodiments, the intrinsic viscosity is 0.3 to about 0.5 deciliter per gram, specifically 0.31 to about 0.5 deciliter per gram, more specifically about 0.35 to about 0.47 deciliter per gram.

The composition comprises about 40 to about 70 weight percent of the poly(phenylene ether)-polysiloxane block copolymer reaction product, based on the total weight of the composition. With this range, the reaction product amount can be about 45 to about 65 weight percent, specifically about 50 to about 61 weight percent.

The poly(phenylene ether) may be blended with vinyl aromatic resins. The vinyl aromatic resins are derived from polymer precursors that contain at least 25% by weight of structural units derived from a monomer of the formula (5):

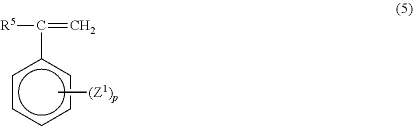

wherein R⁵ is hydrogen, lower alkyl or halogen; Z¹ is vinyl, halogen or lower alkyl; and p is from 0 to about 5. These polymers include homopolymers of styrene, chlorostyrene, and vinyltoluene, random copolymers of styrene with one or more monomers illustrated by acrylonitrile, butadiene, alpha-methylstyrene, ethylvinylbenzene, divinylbenzene and maleic anhydride, and rubber-modified polystyrenes comprising blends and grafts, wherein the rubber is a polybutadiene or a rubbery copolymer of about 98 to 70% styrene and about 2 to 30% diene monomer. Polystyrenes are miscible with polyphenylene ether in all proportions, and any such blend may contain polystyrene in amounts of about 5 to about 95 wt % and most often about 25 to about 75 wt %, based on the total weight of the polymers. In an embodiment, the composition comprises 10 to 40 wt %, specifically 15 to 35 wt % of a polystyrene, based on the total weight of the flame retardant composition.

The poly(phenylene ether) may be blended with polyamides. Exemplary polyamides are polypyrrolidone (nylon-4), polycaprolactam (nylon-6), polycapryllactam (nylon-8), polyhexamethylene adipamide (nylon-6,6), polyundecanolactam (nylon-11), polydodecanolactam (nylon-12), polyhexamethylene azelaiamide (nylon-6,9), polyhexamethylene, sebacamide (nylon-6,10), polyhexamethylene isophthalamide (nylon-6,I), polyhexamethylene terephthalamide (nylon-6,T), polyamides of hexamethylene diamine and n-dodecanedioic acid (nylon-6,12), as well as polyamides resulting from terephthalic acid and/or isophthalic acid and trimethyl hexamethylene diamine, polyamides resulting from adipic acid and meta xylenediamines, polyamides resulting from adipic acid, azelaic acid and 2,2-bis-(p-aminocyclohexyl)propane, polyamides resulting from terephthalic acid and 4,4′-diamino-dicyclohexylmethane, and combinations comprising one or more of the foregoing polyamides. The composition may comprise two or more polyamides. For example the polyamide may comprise nylon-6 and nylon-6,6.

Copolymers of the foregoing polyamides are also suitable for use in blends with polyphenylene ethers. Exemplary polyamide copolymers comprise copolymers of hexamethylene adipamide/caprolactam (nylon-6,6/6), copolymers of caproamide/undecamide (nylon-6/11), copolymers of caproamide/dodecamide (nylon-6/12), copolymers of hexamethylene adipamide/hexamethylene isophthalamide (nylon-6,6/6,I), copolymers of hexamethylene adipamide/hexamethylene terephthalamide (nylon-6,6/6,T), copolymers of hexamethylene adipamide/hexamethylene azelaiamide (nylon-6,6/6,9), and combinations thereof.

The polyphenylene ethers may also be blended with polyarylene sulfides. Polyarylene sulfides are known polymers comprising a plurality of structural units of the formula (6):

—R—S— (6)

wherein R is an aromatic radical such as phenylene, biphenylene, naphthylene, oxydiphenyl, diphenyl sulfone, or is a lower alkyl radical, or a lower alkoxy radical, or halogen substituted derivatives thereof. The lower alkyl and alkoxy substituents typically have about one to about six carbon atoms, for example methyl, ethyl, propyl, isobutyl, n-hexyl, and the like. Preferably, the polyarylene sulfide is a polyphenylene sulfide having repeating structural units of formula (7).

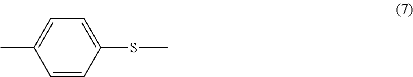

The polyarylene sulfide preferably has a melt index of about 10 grams to about 10,000 grams per 10 minutes when measured by ASTM D-1238-74 (315.6° C.; load, 5 kg). In another embodiment, the polyarylene sulfide will have an inherent viscosity within the range of about 0.05 to about 0.4, and more preferably about 0.1 to about 0.35, as determined at 206° C. in 1-chloronaphthalene at a polymer concentration of 0.4-g/100 mL solution.

Suitable polyarylene sulfides may be prepared according to U.S. Pat. No. 3,354,129, by reacting at least one polyhalo-substituted cyclic compound containing unsaturation between adjacent ring atoms such as 1,2-dichlorobenzene, 1,3-dichlorobenzene, 2,5-dibromobenzene and 2,5-dichlorotoluene with an alkali metal sulfide in a polar organic compound at an elevated temperature. The alkali metal sulfides are generally monosulfides of sodium, potassium, lithium, rubidium, and cesium. Generally the polar organic compound will substantially dissolve both the alkali metal sulfide and the polyhalo-substituted aromatic compound or other reaction by-products. The polymers can also be manufactured by the method described in British Pat. No. 962,941 wherein metal salts of halothiophenols are heated to a polymerization temperature.

Suitable alloys or blends of polyarylene ether and polyarylene sulfide comprise, based on the total amount of thermoplastic resin in the composition, an amount of greater than or equal to about 10, preferably greater than or equal to about 20, and more preferably greater than or equal to about 25 wt % of polyarylene sulfide. It is generally desirable to have the polyarylene sulfide present in an amount less than or equal to about 99, preferably less than or equal to about 80, most preferably less than or equal to about 70 wt % of the total amount of thermoplastic resin. The polyarylene ether is generally present in an amount of greater than or equal to about 1, preferably greater than or equal to about 5, more preferably greater than or equal to about 10, and most preferably greater than or equal to about 15 wt % of the total amount of thermoplastic resin in the composition. It is generally desirable to have the polyarylene ether present in an amount less than or equal to about 90, preferably less than or equal to about 50, more preferably less than or equal to about 35, and most preferably less than or equal to about 28 wt % of the total amount of thermoplastic resin.

The thermoplastic resin in the composition comprises an amount of greater than or equal about 15, preferably greater than or equal to about 20, more preferably greater than or equal to about 25, most preferably greater than or equal to about 35 wt % of the total composition. Also preferred is an amount less than or equal to about 85, preferably less than or equal to about 70, and more preferably less than or equal to about 65 wt % of the total composition.

The flame retardant composition can further include impact modifier(s). These impact modifiers include elastomer-modified graft copolymers comprising (i) an elastomeric (i.e., rubbery) polymer substrate having a Tg less than or equal to 10° C., more specifically less than or equal to −10° C., or more specifically −40° to −80° C., and (ii) a rigid polymeric superstrate grafted to the elastomeric polymer substrate. As is known, elastomer-modified graft copolymers can be prepared by first providing the elastomeric polymer, then polymerizing the constituent monomer(s) of the rigid phase in the presence of the elastomer to obtain the graft copolymer. The grafts can be attached as graft branches or as shells to an elastomer core. The shell can merely physically encapsulate the core, or the shell can be partially or essentially completely grafted to the core.

Materials for use as the elastomer phase include, for example, conjugated diene rubbers; copolymers of a conjugated diene with less than or equal to 50 wt % of a copolymerizable monomer; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl (meth)acrylates; elastomeric copolymers of C₁₋₈ alkyl (meth)acrylates with butadiene and/or styrene; or combinations comprising at least one of the foregoing elastomers.

Conjugated diene monomers for preparing the elastomer phase include those of formula (8)

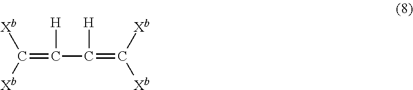

wherein each X^{b} is independently hydrogen, C₁-C₅ alkyl, or the like. Examples of conjugated diene monomers that can be used are butadiene, isoprene, 1,3-heptadiene, methyl-1,3-pentadiene, 2,3-dimethyl-1,3-butadiene, 2-ethyl-1,3-pentadiene; 1,3- and 2,4-hexadienes, and the like, as well as combinations comprising at least one of the foregoing conjugated diene monomers. Specific conjugated diene homopolymers include polybutadiene and polyisoprene.

Copolymers of a conjugated diene rubber can also be used, for example those produced by aqueous radical emulsion polymerization of a conjugated diene and at least one monomer copolymerizable therewith. Monomers that are useful for copolymerization with the conjugated diene include monovinylaromatic monomers containing condensed aromatic ring structures, such as vinyl naphthalene, vinyl anthracene, and the like, or monomers of formula (9)

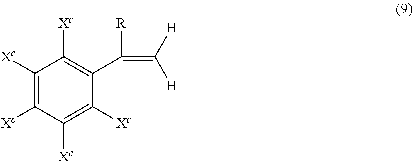

wherein each X^{c} is independently hydrogen, C₁-C₁₂ alkyl, C₃-C₁₂ cycloalkyl, C₆-C₁₂ aryl, C₇-C₁₂ aralkyl, C₇-C₁₂ alkylaryl, C₁-C₁₂ alkoxy, C₃-C₁₂ cycloalkoxy, C₆-C₁₂ aryloxy, chloro, bromo, or hydroxy, and R is hydrogen, C₁-C₅ alkyl, bromo, or chloro. monovinylaromatic monomers that can be used include styrene, 3-methylstyrene, 3,5-diethylstyrene, 4-n-propylstyrene, alpha-methylstyrene, alpha-methyl vinyltoluene, alpha-chloro styrene, alpha-bromostyrene, dichlorostyrene, dibromostyrene, tetra-chlorostyrene, and the like, and combinations comprising at least one of the foregoing compounds. Styrene and/or alpha-methylstyrene can be used as monomers copolymerizable with the conjugated diene monomer.

Other monomers that can be copolymerized with the conjugated diene are monovinylic monomers such as itaconic acid, acrylamide, N-substituted acrylamide or methacrylamide, maleic anhydride, maleimide, N-alkyl-, aryl-, or haloaryl-substituted maleimide, glycidyl (meth)acrylates, and monomers of the generic formula (10)

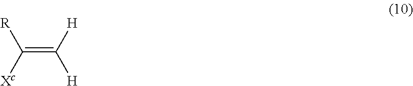

wherein R is hydrogen, C₁-C₅ alkyl, bromo, or chloro, and X^{c} is cyano, C₁-C₁₂ alkoxycarbonyl, C₁-C₁₂ aryloxycarbonyl, hydroxy carbonyl, or the like. Examples of monomers of formula (21a) include acrylonitrile, methacrylonitrile, alpha-chloroacrylonitrile, beta-chloroacrylonitrile, alpha-bromoacrylonitrile, acrylic acid, methyl (meth)acrylate, ethyl (meth)acrylate, n-butyl (meth)acrylate, t-butyl (meth)acrylate, n-propyl (meth)acrylate, isopropyl (meth)acrylate, 2-ethylhexyl (meth)acrylate, and the like, and combinations comprising at least one of the foregoing monomers. Monomers such as n-butyl acrylate, ethyl acrylate, and 2-ethylhexyl acrylate are commonly used as monomers copolymerizable with the conjugated diene monomer. Combinations of the foregoing monovinyl monomers and monovinylaromatic monomers can also be used.

In an embodiment, the flame retardant composition comprises a rubber-modified polystyrene. The rubber-modified polystyrene comprises polystyrene and polybutadiene. Rubber-modified polystyrenes are sometimes referred to as “high-impact polystyrenes” or “HIPS”. In some embodiments, the rubber-modified polystyrene comprises 80 to 96 weight percent polystyrene, specifically 88 to 94 weight percent polystyrene; and 4 to 20 weight percent polybutadiene, specifically 6 to 12 weight percent polybutadiene, based on the weight of the rubber-modified polystyrene. In some embodiments, the rubber-modified polystyrene has an effective gel content of 10 to 35 percent. Suitable rubber-modified polystyrenes are commercially available as, for example, HIPS3190 from SABIC Innovative Plastics.

The flame retardant composition comprises the rubber-modified polystyrene in an amount of about 3 to about 40 weight percent, specifically about 5 to about 30 weight percent, more specifically about 7 to about 35 weight percent, more specifically about 8 to about 25 weight percent, based on the total weight of the flame retardant composition.

(Meth)acrylate monomers for use in the elastomeric phase can be cross-linked, particulate emulsion homopolymers or copolymers of C₁₋₈ alkyl (meth)acrylates, in particular C₄₋₆ alkyl acrylates, for example n-butyl acrylate, t-butyl acrylate, n-propyl acrylate, isopropyl acrylate, 2-ethylhexyl acrylate, and the like, and combinations comprising at least one of the foregoing monomers. The C₁₋₈ alkyl (meth)acrylate monomers can optionally be polymerized in admixture with less than or equal to 15 wt % of comonomers of formulas (8), (9), or (10), based on the total monomer weight. comonomers include but are not limited to butadiene, isoprene, styrene, methyl methacrylate, phenyl methacrylate, phenethylmethacrylate, N-cyclohexylacrylamide, vinyl methyl ether or acrylonitrile, and combinations comprising at least one of the foregoing comonomers. Optionally, less than or equal to 5 wt % of a polyfunctional crosslinking comonomer can be present, based on the total monomer weight. Such polyfunctional crosslinking comonomers can include, for example, divinylbenzene, alkylenediol di(meth)acrylates such as glycol bisacrylate, alkylenetriol tri(meth)acrylates, polyester di(meth)acrylates, bisacrylamides, triallyl cyanurate, triallyl isocyanurate, allyl (meth)acrylate, diallyl maleate, diallyl fumarate, diallyl adipate, triallyl esters of citric acid, triallyl esters of phosphoric acid, and the like, as well as combinations comprising at least one of the foregoing crosslinking agents.

The elastomer phase can be polymerized by mass, emulsion, suspension, solution or combined processes such as bulk-suspension, emulsion-bulk, bulk-solution or other techniques, using continuous, semi-batch, or batch processes. The particle size of the elastomer substrate is not critical. For example, an average particle size of 0.001 to 25 micrometers, specifically 0.01 to 15 micrometers, or even more specifically 0.1 to 8 micrometers can be used for emulsion based polymerized rubber lattices. A particle size of 0.5 to 10 micrometers, specifically 0.6 to 1.5 micrometers can be used for bulk polymerized rubber substrates. Particle size can be measured by simple light transmission methods or capillary hydrodynamic chromatography (CHDF). The elastomer phase can be a particulate, moderately cross-linked conjugated butadiene or C₄₋₆ alkyl acrylate rubber, and specifically has a gel content greater than 70%. Also useful are combinations of butadiene with styrene and/or C₄₋₆ alkyl acrylate rubbers.

The elastomeric phase comprises 5 to 95 wt % of the total graft copolymer, more specifically 20 to 90 wt %, and even more specifically 40 to 85 wt % of the elastomer-modified graft copolymer, the remainder being the rigid graft phase.

The rigid phase of the elastomer-modified graft copolymer can be formed by graft polymerization of a combination comprising a monovinylaromatic monomer and optionally at least one comonomer in the presence of at least one elastomeric polymer substrates. The above-described monovinylaromatic monomers of formula (9) can be used in the rigid graft phase, including styrene, alpha-methyl styrene, halostyrenes such as dibromostyrene, vinyltoluene, vinylxylene, butylstyrene, para-hydroxystyrene, methoxystyrene, or the like, or combinations comprising at least one of the foregoing monovinylaromatic monomers. Useful comonomers include, for example, the above-described monovinylic monomers and/or monomers of the general formula (10). In an embodiment, R is hydrogen or C₁-C₂ alkyl, and X^{c} is cyano or C₁-C₁₂ alkoxycarbonyl. Comonomers for use in the rigid phase include acrylonitrile, methacrylonitrile, methyl (meth)acrylate, ethyl (meth)acrylate, n-propyl (meth)acrylate, isopropyl (meth)acrylate, and the like, and combinations comprising at least one of the foregoing comonomers.

The relative ratio of monovinylaromatic monomer and comonomer in the rigid graft phase can vary widely depending on the type of elastomer substrate, type of monovinylaromatic monomer(s), type of comonomer(s), and the desired properties of the impact modifier. The rigid phase can generally comprise less than or equal to 100 wt % of monovinyl aromatic monomer, specifically 30 to 100 wt %, more specifically 50 to 90 wt % monovinylaromatic monomer, with the balance of the rigid phase being comonomer(s).

Depending on the amount of elastomer-modified polymer present, a separate matrix or continuous phase of ungrafted rigid polymer or copolymer can be simultaneously obtained along with the elastomer-modified graft copolymer. Typically, such impact modifiers comprise 40 to 95 wt % elastomer-modified graft copolymer and 5 to 65 wt % graft copolymer, based on the total weight of the impact modifier. In another embodiment, such impact modifiers comprise 50 to 85 wt %, more specifically 75 to 85 wt % rubber-modified graft copolymer, together with 15 to 50 wt %, more specifically 15 to 25 wt % graft copolymer, based on the total weight of the impact modifier.

In an embodiment, the aromatic vinyl copolymer comprises “free” styrene-acrylonitrile copolymer (SAN), i.e., styrene-acrylonitrile copolymer that is not grafted onto another polymeric chain. In a particular embodiment, the free styrene-acrylonitrile copolymer can have a molecular weight of 50,000 to 200,000 Daltons on a polystyrene standard molecular weight scale and can comprise various proportions of styrene to acrylonitrile. For example, free SAN can comprise 75 weight percent styrene and 25 weight percent acrylonitrile based on the total weight of the free SAN copolymer. Free SAN can optionally be present by virtue of the addition of a grafted rubber impact modifier in the composition that contains free SAN, and/or free SAN can by present independent of other impact modifiers in the composition.

Another specific type of elastomer-modified impact modifier comprises structural units derived from at least one silicone rubber monomer, a branched acrylate rubber monomer having the formula H₂C═C(Rd)C(O)OCH₂CH₂R^{e}, wherein Rd is hydrogen or a C₁-C₈ linear or branched alkyl group and R^{e} is a branched C₃-C₁₆ alkyl group; a first graft link monomer; a polymerizable alkenyl-containing organic material; and a second graft link monomer. The silicone rubber monomer can comprise, for example, a cyclic siloxane, tetraalkoxysilane, trialkoxysilane, (acryloxy)alkoxysilane, (mercaptoalkyl)alkoxysilane, vinylalkoxysilane, or allylalkoxysilane, alone or in combination, e.g., decamethylcyclopentasiloxane, dodecamethylcyclohexasiloxane, trimethyltriphenylcyclotrisiloxane, tetramethyltetraphenylcyclotetrasiloxane, tetramethyltetravinylcyclotetrasiloxane, octaphenylcyclotetrasiloxane, octamethylcyclotetrasiloxane and/or tetraethoxysilane.

Branched acrylate rubber monomers include iso-octyl acrylate, 6-methyloctyl acrylate, 7-methyloctyl acrylate, 6-methylheptyl acrylate, and the like, or a combination comprising at least one of the foregoing. The polymerizable alkenyl-containing organic material can be, for example, a monomer of formula (9) or (10), e.g., styrene, alpha-methylstyrene, acrylonitrile, methacrylonitrile, or an unbranched (meth)acrylate such as methyl methacrylate, 2-ethylhexyl methacrylate, methyl acrylate, ethyl acrylate, n-propyl acrylate, or the like, alone or in combination.

The first graft link monomer can be an (acryloxy)alkoxysilane, a (mercaptoalkyl)alkoxysilane, a vinylalkoxysilane, or an allylalkoxysilane, alone or in combination, e.g., (gamma-methacryloxypropyl)(dimethoxy)methylsilane and/or (3-mercaptopropyl)trimethoxysilane. The second graft link monomer is a polyethylenically unsaturated compound having at least one allyl group, such as allyl methacrylate, triallyl cyanurate, triallyl isocyanurate, and the like, or a combination comprising at least one of the foregoing.

The silicone-acrylate impact modifiers can be prepared by emulsion polymerization, wherein, for example a silicone rubber monomer is reacted with a first graft link monomer at a temperature from 30 to 110° C. to form a silicone rubber latex, in the presence of a surfactant such as dodecylbenzenesulfonic acid. Alternatively, a cyclic siloxane such as cyclooctamethyltetrasiloxane and a tetraethoxyorthosilicate can be reacted with a first graft link monomer such as (gamma-methacryloxypropyl)methyldimethoxysilane. A branched acrylate rubber monomer is then polymerized with the silicone rubber particles, optionally in presence of a cross linking monomer, such as allyl methacrylate, in the presence of a free radical generating polymerization catalyst such as benzoyl peroxide. This latex is then reacted with a polymerizable alkenyl-containing organic material and a second graft link monomer. The latex particles of the graft silicone-acrylate rubber hybrid can be separated from the aqueous phase through coagulation (by treatment with a coagulant) and dried to a fine powder to produce the silicone-acrylate rubber impact modifier. This method can be generally used for producing the silicone-acrylate impact modifier having a particle size of 100 nanometers to 2 micrometers.

Processes known for the formation of the foregoing elastomer-modified graft copolymers include mass, emulsion, suspension, and solution processes, or combined processes such as bulk-suspension, emulsion-bulk, bulk-solution or other techniques, using continuous, semi-batch, or batch processes.

In an embodiment the foregoing types of impact modifiers are prepared by an emulsion polymerization process that is free of basic materials such as alkali metal salts of C₆₋₃₀ fatty acids, for example sodium stearate, lithium stearate, sodium oleate, potassium oleate, and the like, alkali metal carbonates, amines such as dodecyl dimethyl amine, dodecyl amine, and the like, and ammonium salts of amines. Such materials are commonly used as surfactants in emulsion polymerization, and can catalyze transesterification and/or degradation of polycarbonates. Instead, ionic sulfate, sulfonate or phosphate surfactants can be used in preparing the impact modifiers, particularly the elastomeric substrate portion of the impact modifiers. Useful surfactants include, for example, C₁₋₂₂ alkyl or C₇₋₂₅ alkylaryl sulfonates, C₁₋₂₂ alkyl or C₇₋₂₅ alkylaryl sulfates, C₁₋₂₂ alkyl or C₇₋₂₅ alkylaryl phosphates, substituted silicates, or a combination comprising at least one of the foregoing. A specific surfactant is a C₆₋₁₆, specifically a C₈₋₁₂ alkyl sulfonate. This emulsion polymerization process is described and disclosed in various patents and literature of such companies as Rohm & Haas and General Electric Company. In the practice, any of the above-described impact modifiers can be used providing it is free of the alkali metal salts of fatty acids, alkali metal carbonates and other basic materials.

A specific impact modifier of this type is a methyl methacrylate-butadiene-styrene (MBS) impact modifier wherein the butadiene substrate is prepared using above-described sulfonates, sulfates, or phosphates as surfactants. Other examples of elastomer-modified graft copolymers in addition to ABS and MBS include but are not limited to acrylonitrile-styrene-butyl acrylate (ASA), methyl methacrylate-acrylonitrile-butadiene-styrene (MABS), and acrylonitrile-ethylene-propylene-diene-styrene (AES). When present, impact modifiers can be present in the flame retardant composition in amounts of 5 to 30 percent by weight, based on the total weight of the flame retardant composition.

In an embodiment, the flame retardant composition may contain reinforcing fillers. Examples of reinforcing fillers are glass fibers, carbon fibers, metal fibers, and the like.

The glass fibers may be flat or round fibers. Flat glass fibers have an elliptical cross-sectional area, while round fibers have a circular cross-sectional area, where the cross-sectional areas are measured perpendicular to the longitudinal axis of the fiber. The glass fibers may be manufactured from “E-glass,” “A-glass,” “C-glass,” “D-glass,” “R-glass,” “S-glass,” as well as E-glass derivatives that are fluorine-free and/or boron-free. The glass fibers may be woven or non-woven. The glass fibers can have a diameter of about 3 micrometers to about 25 micrometers, specifically about 4 micrometers to about 20 micrometers, and more specifically about 8 micrometers to about 15 micrometers.

The carbon fibers may be either carbon nanotubes or carbon fibers derived from pitch or polyacrylonitrile. The carbon nanotubes can be single wall carbon nanotubes or multiwall carbon nanotubes. The carbon nanotubes can have diameters of about 2.7 nanometers to about 100 nanometers and can have aspect ratios of about 5 to about 100. The aspect ratio is defined as the ratio of the length to the diameter.

The carbon fibers derived from pitch and polyacrylonitrile have a different microstructure from the carbon nanotubes. The carbon fibers can have a diameter of about 3 micrometers to about 25 micrometers, specifically about 4 micrometers to about 20 micrometers, and more specifically about 8 micrometers to about 15 micrometers and can have aspect ratios of about 0.5 to about 100.

The metal fibers can be whiskers (having diameters of less than 100 nanometers) or can have diameters in the micrometer regime. Metal fibers in the micrometer regime can have diameters of about 3 to about 30 micrometers. Exemplary metal fibers comprise stainless steel, aluminum, iron, nickel, copper, or the like, or a combination comprising at least one of the foregoing metals.

The flame retardant composition comprises the reinforcing fibers in an amount of about 15 to about 45 wt %, specifically about 20 to about 40 wt %, and more specifically about 28 to about 33 wt %, based on the total weight of the flame retardant composition.

The flame retardant composition may also comprise mineral fillers. In an embodiment, the mineral fillers serve as synergists. The synergist facilitates an improvement in the flame retardant properties when added to the flame retardant composition over a comparative composition that contains all of the same ingredients in the same quantities except for the synergist. Examples of mineral fillers are mica, talc, calcium carbonate, dolomite, wollastonite, barium sulfate, silica, kaolin, feldspar, barytes, or the like, or a combination comprising at least one of the foregoing mineral fillers. The mineral filler may have an average particle size of about 0.1 to about 20 micrometers, specifically about 0.5 to about 10 micrometers, and more specifically about 1 to about 3 micrometers.

The mineral filler is present in amounts of about 0.1 to about 20 wt %, specifically about 0.5 to about 15 wt %, and more specifically about 1 to about 5 wt %, based on the total weight of the flame retardant composition. An exemplary mineral filler is talc.

The flame retardant composition may also optionally contain additives such as antioxidants, antiozonants, stabilizers, thermal stabilizers, mold release agents, dyes, colorants, pigments, flow modifiers, or the like, or a combination comprising at least one of the foregoing additives.

As noted above, the flame retardant composition comprises a flame retarding agent. The flame retarding agent is a phosphazene compound. In an embodiment, the flame retarding agent is a phenoxyphosphazene oligomer.

The phosphazene compound used in the flame retardant composition is an organic compound having a —P═N— bond in the molecule. In an embodiment, the phosphazene compound comprises at least one species of the compound selected from the group consisting of a cyclic phenoxyphosphazene represented by the formula (11) below; a chainlike phenoxyphosphazene represented by the formula (12) below; and a crosslinked phenoxyphosphazene compound obtained by crosslinking at least one species of phenoxyphosphazene selected from those represented by the formulae (11) and (12) below, with a crosslinking group represented by the formula (11) below:

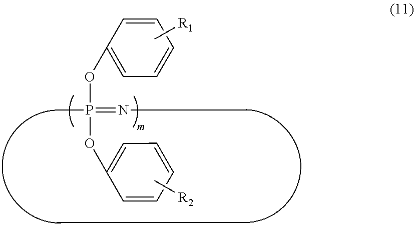

where in the formula (11), m represents an integer of about 3 to about 25, R₁ and R₂ are the same or different and are independently a hydrogen, a halogen, a C₁₋₁₂ alkoxy, or a C₁₋₁₂ alkyl.

The chainlike phenoxyphosphazene represented by the formula (12) below:

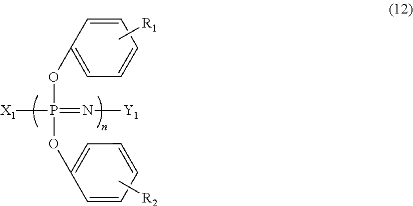

where in the formula (12), X¹ represents a —N═P(OPh)₃ group or a —N═P(O)OPh group, Y¹ represents a —P(OPh)₄ group or a —P(O) (OPh)₂ group, n represents an integer from 3 to 10000, Ph represents a phenyl group, R1 and R2 are the same or different and are independently a hydrogen, a halogen, a C₁₋₁₂ alkoxy, or a C₁₋₁₂ alkyl.

The phenoxyphosphazenes may also have a crosslinking group represented by the formula (13) below:

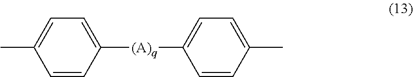

where in the formula (13), A represents —C(CH3)₂-, —SO₂—, —S—, or —O—, and q is 0 or 1.

In one embodiment, the phenoxyphosphazene compound has a structure represented by the formula (14)

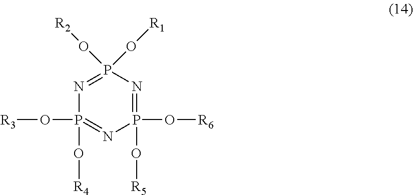

where R1 to R6 can be the same of different and can be an aryl group, a fused aryl group, an aralkyl group, a C₁₋₁₂ alkoxy, a C₁₋₁₂ alkyl, or a combination thereof.

In one embodiment, the phenoxyphosphazene compound has a structure represented by the formula (15)

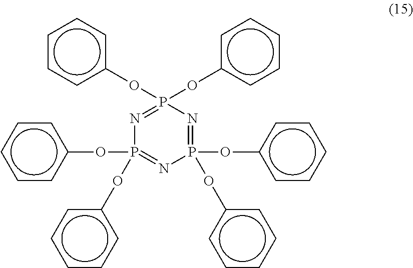

Commercially available phenoxyphosphazenes having the aforementioned structures are LY202® manufactured and distributed by Lanyin Chemical Co., Ltd, FP-110® manufactured and distributed by Fushimi Pharmaceutical Co., Ltd, and SPB-100® manufactured and distributed by Otsuka Chemical Co., Ltd.

The cyclic phenoxyphosphazene compound represented by the formula (11) may be exemplified by compounds such as phenoxy cyclotriphosphazene, octaphenoxy cyclotetraphosphazene, and decaphenoxy cyclopentaphosphazene, obtained by allowing ammonium chloride and phosphorus pentachloride to react at about 120 to about 130° C. to obtain a mixture containing cyclic and straight chain chlorophosphazenes, extracting cyclic chlorophosphazenes such as hexachloro cyclotriphosphazene, octachloro cyclotetraphosphazene, and decachloro cyclopentaphosphazene, and then substituting it with a phenoxy group. The cyclic phenoxyphosphazene compound may be a compound in which m in the formula (11) represents an integer of about 3 to about 8.

The chainlike phenoxyphosphazene compound represented by the formula (12) is exemplified by a compound obtained by subjecting hexachlorocyclotriphosphazene, obtained by the above-described method, to ring-opening polymerization at about 220 to about 250° C., and then substituting thus obtained chainlike dichlorophosphazene having a degree of polymerization of about 3 to about 10000 with phenoxy groups. The chain-like phenoxyphosphazene compound has a value of n in the formula (12) of about 3 to about 1000, specifically about 5 to about 100, and more specifically about 6 to about 25.

The crosslinked phenoxyphosphazene compound may be exemplified by compounds having a crosslinked structure of a 4,4′-diphenylene group, such as a compound having a crosslinked structure of a 4,4′-sulfonyldiphenylene (bisphenol S residue), a compound having a crosslinked structure of a 2,2-(4,4′-diphenylene) isopropylidene group, a compound having a crosslinked structure of a 4,4′-oxydiphenylene group, and a compound having a crosslinked structure of a 4,4′-thiodiphenylene group. The phenylene group content of the crosslinked phenoxyphosphazene compound is generally about 50 to about 99.9 wt %, and specifically about 70 to about 90 wt %, based on the total number of phenyl group and phenylene group contained in the cyclic phosphazene compound represented by the formula (11) and/or the chainlike phenoxyphosphazene compound represented by the formula (12). The crosslinked phenoxyphosphazene compound may be particularly preferable if it doesn't have any free hydroxyl groups in the molecule thereof. In an exemplary embodiment, the phosphazene compound comprises the cyclic phosphazene.

It is desirable for the flame retardant composition to comprise the phosphazene compound in an amount of about 1 to about 20 wt %, specifically about 2 to about 16 wt %, and more specifically about 2.5 wt % to about 14 wt %, based on the total weight of the flame retardant composition.

In an embodiment, the flame retardant composition may comprise an anti-drip agent. Fluorinated polyolefin and/or polytetrafluoroethylene may be used as an anti-drip agent. Anti-drip agents may also be used, for example a fibril forming or non-fibril forming fluoropolymer such as polytetrafluoroethylene (PTFE). The anti-drip agent may be encapsulated by a rigid copolymer such as, for example styrene acrylonitrile (SAN). PTFE encapsulated in SAN is known as TSAN. Encapsulated fluoropolymers may be made by polymerizing the encapsulating polymer in the presence of the fluoropolymer, for example, in an aqueous dispersion. TSAN may provide significant advantages over PTFE, in that TSAN may be more readily dispersed in the composition. A suitable TSAN may comprise, for example, about 50 wt % PTFE and about 50 wt % SAN, based on the total weight of the encapsulated fluoropolymer. The SAN may comprise, for example, about 75 wt % styrene and about 25 wt % acrylonitrile based on the total weight of the copolymer. Alternatively, the fluoropolymer may be pre-blended in some manner with a second polymer, such as for, example, an aromatic polycarbonate resin or SAN to form an agglomerated material for use as an anti-drip agent. Either method may be used to produce an encapsulated fluoropolymer.

The anti-drip agent may be added in the form of relatively large particles having a number average particle size of about 0.3 to about 0.7 mm, specifically about 0.4 to about 0.6 millimeters. The anti-drip agent may be used in amounts of 0.01 wt % to about 5.0 wt %, based on the total weight of the flame retardant composition.

The flame retardant composition may also comprise mineral fillers. In an embodiment, the mineral fillers serve as synergists. In an embodiment, a small portion of the mineral filler may be added to the flame retardant composition in addition to a synergist, which can be another mineral filler. The synergist facilitates an improvement in the flame retardant properties when added to the flame retardant composition over a comparative composition that contains all of the same ingredients in the same quantities except for the synergist. Examples of mineral fillers are mica, talc, calcium carbonate, dolomite, wollastonite, barium sulfate, silica, kaolin, feldspar, barytes, or the like, or a combination comprising at least one of the foregoing mineral fillers. The mineral filler may have an average particle size of about 0.1 to about 20 micrometers, specifically about 0.5 to about 10 micrometers, and more specifically about 1 to about 3 micrometers.

Other additives such as anti-oxidants, anti-ozonants, mold release agents, thermal stabilizers, levelers, viscosity modifying agents, free-radical quenching agents, other polymers or copolymers such as impact modifiers, or the like.

The preparation of the flame-retardant composition can be achieved by blending the ingredients under conditions that produce an intimate blend. All of the ingredients can be added initially to the processing system, or else certain additives can be pre-compounded with one or more of the primary components.

In an embodiment, the flame-retardant composition is manufactured by blending the polycarbonate copolymer with the phosphazene compound. The blending can be dry blending, melt blending, solution blending or a combination comprising at least one of the foregoing forms of blending.

In an embodiment, the flame-retardant composition can be dry blended to form a mixture in a device such as a Henschel mixer or a Waring blender prior to being fed to an extruder, where the mixture is melt blended. In another embodiment, a portion of the polycarbonate copolymer can be premixed with the phosphazene compound to form a dry preblend. The dry preblend is then melt blended with the remainder of the polyamide composition in an extruder. In an embodiment, some of the flame retardant composition can be fed initially at the mouth of the extruder while the remaining portion of the flame retardant composition is fed through a port downstream of the mouth.

Blending of the flame retardant composition involves the use of shear force, extensional force, compressive force, ultrasonic energy, electromagnetic energy, thermal energy or combinations comprising at least one of the foregoing forces or forms of energy and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, barrels with pins, rolls, rams, helical rotors, or combinations comprising at least one of the foregoing.

Blending involving the aforementioned forces may be conducted in machines such as single or multiple screw extruders, Buss kneader, Henschel, helicones, Ross mixer, Banbury, roll mills, molding machines such as injection molding machines, vacuum forming machines, blow molding machine, or then like, or combinations comprising at least one of the foregoing machines.

The flame-retardant composition can be introduced into the melt blending device in the form of a masterbatch. In such a process, the masterbatch may be introduced into the blending device downstream of the point where the remainder of the flame retardant composition is introduced.

In an embodiment, the flame-retardant composition disclosed herein are used to prepare molded articles such as for example, durable articles, electrical and electronic components, automotive parts, and the like. The compositions can be converted to articles using common thermoplastic processes such as film and sheet extrusion, injection molding, gas-assisted injection molding, extrusion molding, compression molding and blow molding.

The compositions were tested for one or more of the following: UL 94 flame retardance, Izod impact strength, melt viscosity, and heat deflection temperature. The details of these tests used in the examples are known to those of ordinary skill in the art, and may be summarized as follows:

Flammability tests were performed following the procedure of Underwriter's Laboratory Bulletin 94 entitled “Tests for Flammability of Plastic Materials, UL 94”. Several ratings can be applied based on the rate of burning, time to extinguish, ability to resist dripping, and whether or not drips are burning. Samples for testing are bars having dimensions of 125 mm length×13 mm width by no greater than 13 mm thickness. Bar thicknesses were 0.6 mm or 0.8 mm. Materials can be classified according to this procedure as UL 94 HB (horizontal burn), V0, V1, V2, 5VA and/or 5VB on the basis of the test results obtained for five samples; however, the compositions herein were tested and classified only as V0, V1, and V2, the criteria for each of which are described below.

V0: In a sample placed so that its long axis is 180 degrees to the flame, the period of flaming and/or smoldering after removing the igniting flame does not exceed ten (10) seconds and the vertically placed sample produces no drips of burning particles that ignite absorbent cotton. Five bar flame out time is the flame out time for five bars, each lit twice, in which the sum of time to flame out for the first (t₁) and second (t₂) ignitions is less than or equal to a maximum flame out time (t₁+t₂) of 50 seconds.

V1: In a sample placed so that its long axis is 180 degrees to the flame, the period of flaming and/or smoldering after removing the igniting flame does not exceed thirty (30) seconds and the vertically placed sample produces no drips of burning particles that ignite absorbent cotton. Five bar flame out time is the flame out time for five bars, each lit twice, in which the sum of time to flame out for the first (t₁) and second (t₂) ignitions is less than or equal to a maximum flame out time (t₁+t₂) of 250 seconds.

V2: In a sample placed so that its long axis is 180 degrees to the flame, the average period of flaming and/or smoldering after removing the igniting flame does not exceed thirty (30) seconds, but the vertically placed samples produce drips of burning particles that ignite cotton. Five bar flame out time is the flame out time for five bars, each lit twice, in which the sum of time to flame out for the first (t₁) and second (t₂) ignitions is less than or equal to a maximum flame out time (t₁+t₂) of 250 seconds.

In an embodiment, the flame retardant compositions are of particular utility in the manufacture flame retardant articles that pass the UL94 vertical burn tests, in particular the UL94 5VB standard. In the UL94 vertical burn test, a flame is applied to a vertically fastened test specimen placed above a cotton wool pad. To achieve a rating of 5VB, burning must stop within 60 seconds after five applications of a flame to a test bar, and there can be no drips that ignite the pad. Various embodiments of the compositions described herein meet the UL94 5VB standard.

Izod Impact Strength is used to compare the impact resistances of plastic materials. Notched Izod impact strength was determined at both 23° C. and 0° C. using a 3.2-mm thick, molded, notched Izod impact bar. It was determined per ASTM D256. The results are reported in joules/meter.

Heat deflection temperature (HDT) is a relative measure of a material's ability to perform for a short time at elevated temperatures while supporting a load. The test measures the effect of temperature on stiffness: a standard test specimen is given a defined surface stress and the temperature is raised at a uniform rate. HDT was determined as flatwise under 1.82 MPa loading with 3.2 mm thickness bar according to ASTM D648. Results are reported in ° C.

The flame retardant composition is exemplified by the following examples.

### Example 1

This example was conducted to demonstrate the use of polyphenylene ether and the phosphazene compounds in a flame retardant composition. The flame retardant used in these experiments is Rabitle FP-110 from Fushimi pharmaceuticals. Tables 1A and 1B show the ingredients that were used in the flame retardant composition. The Comparative Example in the Table 1B uses resorcinol diphosphate as the flame retardant, while the example (that encompasses the disclosed invention) uses the phosphazene compound. Additional compositions are shown in the Tables 4A, 4B and 4C. The control sample (the Comparative Example of Table 1B), which is based on resorcinol diphosphate as flame retardant contains a phosphorus and polyphenylene ether weight percent of 1.9 and 64 respectively. (See Tables 1B, 4A and 4B respectively.) It is to be noted that the polyphenylene ether weight percent is reported as percentage in total of polyphenylene ether and high impact polystyrene in the formulation (PPE % in total PPE+HIPS). It is also to be noted that in the Table 4C, the control samples are made with bisphenol A disphosphate (BPADP) instead of resorcinol diphosphate (RDP). The NORYL compositions disclosed in the Tables 1A, 4A and 4C are all commercially available from Sabic Innovative Plastics.

TABLE 1A

| | Raw material | |
|---|---|---|
| Description | form | Supplier |
| PPO-0803 | Powder | Polyphenylene ether (poly(2,6-dimethyl- |
| | | 1,4-phenylene ether)) with intrinsic |
| | | viscosity of 0.385 to 0.415 deciliter per |
| | | gram obtained from Sabic. |
| PPO-800 | Powde | Polyphenylene ether (poly(2,6-dimethyl- |
| | | 1,4-phenylene ether)) with intrinsic |
| | | viscosity of 0.445 and 0.475 decilter per |
| | | gram obtained from Sabic. |
| polystyrene modified with polybutadiene | Pellet | Styrolution |
| Tetraphenyl resorcinol diphosphate & | Liquid | Chemtura |
| oligomers. | | |
| Bisphenol A diphosphate | Liquid | Chemtura |
| Phenoxyphosphazene Oligomer | Powder | Fushimi Pharmaceutical, Japan/ID |
| | | Biochem, Korea |
| Milled low density polyethylene | Powder | RMC890 from SABIC Europe milled by |
| | | Smile Plastics |
| Kraton D-1102CS (Styrene butadiene styrene | Pellets | Kraton Polymers and Dynasol |
| block copolymer | | |
| Tris (2,4-di-tert-butylphenyl) phosphite | Powder | CIBA, Chemtura, Everspring |
| Zinc sulphide | Powder | Sachteleben Chemie |
| Zinc oxide | Powder | Narzinc o |
| Polytetrafluoroethylene | Powder | Solvay Solexis |
| Polyphenylene ether-siloxane copolymer | Powder | SABIC-IP |

TABLE 1B

| | Comparative | |
|---|---|---|
| Item Description | Example (wt %) | Example (wt %) |
| Rabitle FP-110 from Fushimi | | 14.18 |
| ZnO | 0.1 | 0.1 |
| ZnS | 0.1 | 0.1 |
| PPO 803 | 50 | 52.13 |
| Tris(di-t-butylphenyl)phosphite | 0.5 | 0.5 |
| PTFE | 0.05 | 0.05 |
| PE, milled 1000 microns | 1.5 | 1.5 |
| SBS | 2.5 | 2.5 |
| Regular HIPS | 27.75 | 28.94 |
| RDP | 17.50 | |

The processing conditions are shown in the Tables 2 and 3 below.

TABLE 2

| | Unit of | |
|---|---|---|
| Parameters | Measure | Settings |
| Compounder Type | none | 28 mm diameter ZSK |
| | | twin-screw extruder |
| Barrel Size | mm | 28 mm |
| | holes | 2 |
| Zone 0 Temp (feed | | 40 |
| zone) | | |
| Zone 1 Temp | ° C. | 180 |
| Zone 2 Temp | ° C. | 210 |
| Zone 3 Temp | ° C. | 260 |
| Zone 4 Temp | ° C. | 260 |
| Zone 5 Temp | ° C. | 270 |
| Zone 6 Temp | ° C. | 270 |
| Zone 7 Temp | ° C. | 270 |
| Zone 8 Temp | ° C. | 280 |
| Die Temp | ° C. | 280 |
| Screw speed | rpm | 300 |
| Throughput | kg/hr | 21-22 |
| Vacuum | MPa | 0.7 |

The polyphenylene ether, HIPS and the phenoxyphosphazene were fed upstream via in the main throat. RDP was fed via liquid injection feeder between barrel Zone 5 and 6. All additives (mold release agent, antioxidants, and the like) were pre-blended with the polyphenylene ether powder in a high speed blender and then fed into the extruder. The molding conditions are detailed in the Table 3.

TABLE 3

| Parameter | Unit of Measure | Settings |
|---|---|---|
| Pre-drying time | Hour | 2 |
| Pre-drying temp | ° C. | 80 |
| Hopper temp | ° C. | 60 |
| Zone 1 temp | ° C. | 220-240 |
| Zone 2 temp | ° C. | 240-260 |
| Zone 3 temp | ° C. | 260-280 |
| Nozzle temp | ° C. | 240-260 |
| Mold temp | ° C. | 60 |
| Screw speed | rpm | 25 |
| Back pressure | bar | 5 |
| Cooling time | s | 20 |
| Molding Machine | none | Engel ES500 75 or 80 |
| | | or 110 ton |
| Shot volume | mm | 62 |
| Injection speed (mm/s) | mm/s | 30 |
| Holding pressure | bar | 45-55 |
| Max. Injection pressure | bar | 62-73 |

TABLE 4A

| | Unit | #1 Control | #2 | #3 | #4 | #5 | #6 | #7 | #8 | #9 | #10 | #11 |
|---|---|---|---|---|---|---|---|---|---|---|---|---|
| Rabitle FP-110 | % | | 14.1 | 12.7 | 12.7 | 14.1 | 15.6 | 12.7 | 15.6 | 15.6 | 15.6 | 14.1 |
| Regular SBS | % | 2.5 | 2.5 | 2.5 | 2.5 | 2.5 | 2.5 | 2.5 | 2.5 | 2.5 | 2.5 | 2.5 |
| rubber | | | | | | | | | | | | |
| ZnS | % | 0.1 | 0.1 | 0.1 | 0.1 | 0.1 | 0.1 | 0.1 | 0.1 | 0.1 | 0.1 | 0.1 |
| PPO 803 | % | 50.0 | 46.9 | 58.3 | 47.7 | 52.1 | 46.1 | 53.0 | 56.3 | 51.2 | 56.3 | 57.3 |
| Tris(di-t- | % | 0.5 | 0.5 | 0.5 | 0.5 | 0.5 | 0.5 | 0.5 | 0.5 | 0.5 | 0.5 | 0.5 |
| butylphenyl)phosphite | | | | | | | | | | | | |
| PTFE | % | 0.05 | 0.05 | 0.05 | 0.05 | 0.05 | 0.05 | 0.05 | 0.05 | 0.05 | 0.05 | 0.05 |
| PE (ld), milled | % | 1.5 | 1.5 | 1.5 | 1.5 | 1.5 | 1.5 | 1.5 | 1.5 | 1.5 | 1.5 | 1.5 |
| 1000 mu | | | | | | | | | | | | |
| HIPS | % | 27.7 | 34.1 | 24.1 | 34.7 | 28.9 | 33.5 | 29.4 | 23.3 | 28.44 | 23.31 | 23.73 |
| RDP | % | 17.5 | | | | | | | | | | |

| | | | | | | | | | | | |
|---|---|---|---|---|---|---|---|---|---|---|---|
| Formulation Total | 99.90 | 99.90 | 99.90 | 99.90 | 99.90 | 99.90 | 99.90 | 99.90 | 99.90 | 99.90 | 99.90 |

TABLE 4B

| | | | #1 | | | | | |
|---|---|---|---|---|---|---|---|---|
| Property | Standard | Units | CONTROL | #2 | #3 | #4 | #5 | #6 |
| % PPO/[PPO + HIPS] | | | 64.3 | 57.9 | 70.7 | 57.9 | 64.3 | 57.9 |
| % P | | | 1.9 | 1.9 | 1.7 | 1.7 | 1.9 | 2.1 |
| MVR 280 C/5 Kg | ISO 1133 | cc/10 min | 52 | 36 | 20 | 29 | 28 | 40 |
| MV 280 C/1500 s⁻¹ | ISO 11443 | Pa-s | 120 | | | | 168.6 | |
| HDT A/f 1.8 MPa | ISO 75/Af | ° C. | 80 | 98 | 110 | 100 | 103 | 97 |
| Vicat B/120 | ISO 306 | ° C. | 102 | 119 | 133 | 122 | 124 | 116 |
| Flexural Modulus | ISO 178 | MPa | 2218 | 2191 | 2225 | 2147 | 2159 | 2091 |
| Flexural Strength | ISO 178 | MPa | 80 | 80 | 88 | 79 | 84 | 78 |
| Izod Notched Impact @ 23° C. | ISO 180/1A | kJ/m2 | 15 | 25 | 24 | 26 | 24 | 25 |
| INT Std Dev | | | 0.45 | 0.85 | 1.22 | 0.67 | 0.29 | 1.51 |
| Izod Notched Impact @ −30° C. | ISO 180/1A | kJ/m2 | 8 | | | | 13 | |
| INT Std Dev | | | 0.63 | | | | 0.72 | |
| Izod Notched Impact @ −40° C. | ISO 180/1A | kJ/m2 | 7 | | | | 9 | |
| INT Std Dev | | | 0.7 | | | | 1.36 | |
| Charpy notched Impact @ 23° C., 7.2 J | ISO 179 | KJ/m2 | 22 | 27 | 25 | 27 | 29 | 28 |
| CNI Std dev | | | 1.03 | 1.7 | 1.95 | 0.98 | 2.1 | 1.92 |
| MAI, puncture Energy; 4.4 m/s @ 23° C. | ISO6603 | J | 32 | 72 | 104 | 86 | 90 | 86 |
| MAI std dev | | | 9.47 | 13.13 | 9.53 | 21.09 | 22.66 | 9.32 |
| MAI, puncture Energy; 4.4 m/s @ −30° C. | ISO6603 | J | 4 | | | | 11 | |
| MAI std dev | | | 0.93 | | | | 6.01 | |
| Tensile Modulus | ISO 527 | MPa | 2275 | 2155 | 2204 | 2141 | 2158 | 2109 |
| Tensile Strength @ Yield | ISO 527 | MPa | 54 | 53 | 59 | 54 | 56 | 52 |
| Tensile Strength @ Break | ISO 527 | MPa | 42 | 43 | 48 | 43 | 45 | 42 |
| Nominal strain @ break | ISO 527 | % | 19 | 18 | 33 | 23 | 20 | 19 |

| | | | | | | | |
|---|---|---|---|---|---|---|---|
| UL-94 1.5 mm | 25 bars | V0 | V1 | V1 | V1 | V0 | V0 |
| p(ftp) V0 1.5 mm | | 0.81 | 0.53 | 0.45 | 0.23 | 0.87 | 0.87 |
| p(ftp)V1 1.5 mm | | 0.99 | 0.99 | 0.99 | 0.97 | 0.99 | 0.99 |

| Property | Standard | Units | #7 | #8 | #9 | #10 | #11 |
|---|---|---|---|---|---|---|---|
| % PPO/[PPO + HIPS] | | | 64.3 | 70.7 | 64.3 | 70.7 | 70.7 |
| % P | | | 1.7 | 2.1 | 2.1 | 2.1 | 1.9 |
| MVR 280 C/5 Kg | ISO 1133 | cc/10 min | 24 | 28 | 34 | 30 | 23 |
| MV 280 C/1500 s⁻¹ | ISO 11443 | Pa-s | | | | | |
| HDT A/f 1.8 MPa | ISO 75/Af | ° C. | 105 | 104 | 100 | 105 | 107 |
| Vicat B/120 | ISO 306 | ° C. | 127 | 126 | 120 | 126 | 130 |
| Flexural Modulus | ISO 178 | MPa | 2186 | 2197 | 2193 | 2190 | 2206 |
| Flexural Strength | ISO 178 | MPa | 86 | 88 | 85 | 88 | 89 |
| Izod Notched Impact @ 23° C. | ISO 180/1A | kJ/m2 | 25 | 24 | 22 | 19 | 23 |
| INT Std Dev | | | 1.73 | 1.39 | 0.35 | 10.9 | 0.48 |
| Izod Notched Impact @ −30° C. | ISO 180/1A | kJ/m2 | | | | | |
| INT Std Dev | | | | | | | |
| Izod Notched Impact @ −40° C. | ISO 180/1A | kJ/m2 | | | | | |
| INT Std Dev | | | | | | | |
| Charpy notched Impact @ 23° C., 7.2 J | ISO 179 | KJ/m2 | 28 | 27 | 28 | 30 | 28 |
| CNI Std dev | | | 0.9 | 1.08 | 0.96 | 1.36 | 1.91 |
| MAI, puncture Energy; 4.4 m/s @ 23° C. | ISO6603 | J | 99 | 100 | 91 | 108 | 93 |
| MAI std dev | | | 13.83 | 6.24 | 9.97 | 8.32 | 17.15 |
| MAI, puncture Energy; 4.4 m/s @ −30° C. | ISO6603 | J | | | | | |
| MAI std dev | | | | | | | |
| Tensile Modulus | ISO 527 | MPa | 2161 | 2173 | 2155 | 2169 | 2193 |
| Tensile Strength @ Yield | ISO 527 | MPa | 56 | 58 | 56 | 58 | 59 |
| Tensile Strength @ Break | ISO 527 | MPa | 45 | 47 | 44 | 46 | 46 |
| Nominal strain @ break | ISO 527 | % | 22 | 37 | 19 | 24 | 27 |

| | | | | | | |
|---|---|---|---|---|---|---|
| UL-94 1.5 mm | 25 bars | V1 | V0 | V0 | V0 | V0 |
| p(ftp) V0 1.5 mm | | 0.61 | 0.99 | 0.89 | 0.87 | 0.81 |
| p(ftp)V1 1.5 mm | | 0.99 | 0.99 | 0.99 | 0.99 | 0.99 |

TABLE 4C

| | | | #1 | #2 | #3 | #4 |
|---|---|---|---|---|---|---|
| | | | NORYL*N1250 | NORYL*N1250 | NORYL*NH6020 | NORYL*NH6020 |
| Formulation | Unit | | Control | Rabitle | Control | Rabitle |
| PPO 800 | % | | 66.9 | 70.2 | | |
| PPO 803 | % | | | | 75.9 | 80.9 |
| LLDPE | % | | 1.28 | 1.28 | 1.24 | 1.24 |
| SEBS/10 wt % PPO | % | | | | 4.55 | 4.55 |
| Tris(di-t-butylphenyl)phosphite | % | | 0.09 | 0.09 | 0.1 | 0.1 |
| MgO | % | | 0.13 | 0.13 | 0.13 | 0.13 |
| ZnS | % | | 0.13 | 0.13 | 0.13 | 0.13 |
| Rabitle FP-110 from Fushimi | % | | | 8.501 | | 9.96 |
| Tribasic Calcium phosphate | % | | | | 3 | 3 |
| HIPS regular | % | | 18.7 | 19.64 | | |
| BPA-DP | % | | 12.8 | | 15 | |
| Formulation Total | | | 100 | 100 | 100 | 100 |
| Properties | | | All Natural colors | | | |
| UL 5VA @ 2.5 mm | | | Pass | Pass | | |
| Dielectric strength | KV/mm | ASTM D149 | 35.3 | 36.5 | | |
| Hot Wire Ignition @ 0.8 mm | PLC | ASTM | | | 0 | 0 |
| | | D3874 | | | | |
| High Current Arc ignition | PLC | | | | 1 | 0 |
| @ 0.8 mm | | | | | | |
| Comparative Tracking Index | PLC | ASTMD3638 | 2 | 2 | | |
| @ 3 mm | | | | | | |
| Glow Wire Ignition Temperature | ° C. | IEC 60695- | 750 | 750 | | |
| 1 mm | | 2-1 | | | | |
| Glow Wire Ignition Temperature | | | 725 | 750 | | |
| 2 mm | | | | | | |
| Glow Wire Ignition Temperature | | | 725 | 750 | | |
| 3 mm | | | | | | |
| Glow Wire Flammability index | | | 960 | 960 | | |
| 1, 2 and 3 mm | | | | | | |

From the Table 4B, it may be seen that all samples that contain the phosphazene compound display a higher Vicat temperature and heat distortion temperature (HDT) than the sample that contains the resorcinol di-phosphate flame retardant. Similarly the notched Izod impact and Charpy notched impact properties (both room temperature and low temperature) are superior for the flame retardant compositions that contain the phosphazene compound additive when compared with those compositions that contain the resorcinol di-phosphate flame retardant.

The multi-axial impact (both room temperature and low temperature) is far more superior for compositions containing the phosphazene compound when compared with compositions that contain the resorcinol di-phosphate flame retardant. The nominal strain at break of certain compositions (Table 4B #s 3, 4 8 and 11) are also higher than the control (#1).

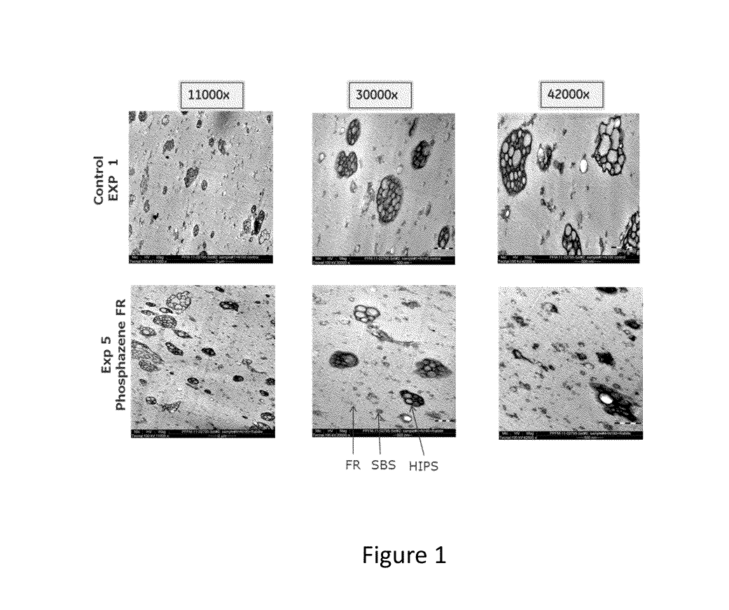

The significant improvement in impact and heat can be explained by very finely dispersed domains of the phosphazene compound in the matrix as shown in FIG. 1. The finely dispersed domains show that unlike resorcinol di-phosphate, the phosphazene does not dissolve in the polyphenylene ether phase and hence does not affect the glass transition temperature and heat performance of the flame retardant composition while imparting good impact properties.

It is clearly seen that the flow (MVR and MV) for phosphazene based compositions are significantly lower than the resorcinol di-phosphate flame retardant based compositions. It is worth mentioning that the throughput during extrusion for compositions containing phosphazene compound were higher (˜22 kg/hr) compared to resorcinol di-phosphate flame retardant compositions (˜18 kg/hr).

From the Table 4B, it may be seen that Samples #2-11, show an improvement in the flow rate and the heat distortion temperature while retaining the flame retardant properties. The melt viscosity rate (MVR) at 280° C. at a force of 5 Kg shows that the samples containing the phosphazene have a lower viscosity with a melt flow rate of 20 to 40 cubic centimeters per 10 minutes. The samples containing the alternative flame retardant (i.e., the control sample #1 containing the RDP) has a melt viscosity rate (MVR) at 280° C. at a force of 5 Kg of 52 cubic centimeters per 10 minutes. This is almost a 25% improvement.

Similarly, the heat distortion temperature measured as per ISO 75/Af is improved from 80° C. for the control sample to greater than 95° C., specifically greater than 100° C., specifically, and more specifically greater than 105° C., when measured at 1.8 MPa.

From Table 4C it may be seen that the electrical properties of the compositions containing phosphazene FR (#2 & #4) are comparable to the compositions containing BPADP as flame retardant (Control NORYL*N1250 and NORYL*NH6020).

### Example 2

This example was conducted to demonstrate the manufacturing and properties of polyphenylene ether-polysiloxane copolymer compositions that contain polystyrene blends and phenoxyphosphazene compounds. In this example, the various compositions were designed to have the same level of phosphorus.

Table 5 shows the ingredients various examples that demonstrate the flame retardant composition as well as control samples (comparative compositions). Use of solid phosphazene compound in polyphenylene ether-polysiloxane-polystyrene blends was evaluated and compared to the corresponding polyphenylene ether-polysiloxane-polystyrene blends as shown in Table 5 (Example (EXP) 2, 4 and 6 vs. EXP 1, 3 and 5). The polystyrene was added in the form of an impact modifier. An additional example (EXP 7) was performed to evaluate performance of the blend without any impact modifier. The blends were extruded on a ZSK 28 mm twin screw extruder in the technology lab line with a maximum throughput of 14-16 kilograms per hour and at about 70% torque. The control samples based on polyphenylene ether (EXP 1) and polyphenylene ether-polysiloxane copolymer (EXP 2) are compounded with resorcinol di-phosphate as flame retardant while all other formulations are based on the phosphazene compound. Since phosphazene improves the impact strength significantly, the use of a 40% lower loading of the phosphazene (EXP 5-7) (as compared with the loading of resorcinol di-phosphate) was also explored. The phosphorous content of the phosphazene compound and the resorcinol di-phosphate are ˜13.4 wt % and ˜10.9 wt % respectively.

The processing parameters for the compositions of the Table 5 are shown in the Tables 6 and 7. Table 6 shows the extrusion conditions, while Table 7 shows the molding conditions.

TABLE 5

| | | | | | | | | N190 with |
|---|---|---|---|---|---|---|---|---|
| | | | N190 | | | | N190 with | PPO- |
| | | | with | | N190 with | N190 with | PPO-Si + | Si + 40% |
| | | Control | PPS- | N190 with | PPO-Si + | 40% less | 40% Less | Phosphazene + |
| | | N190 | Si | Phosphazene | Phosphazene | Phosphazene | Phosphazene | No rubber |
| Formulation | | EXP 1 | EXP 2 | EXP 3 | EXP 4 | EXP 5 | EXP 6 | EXP 7 |
| Phosphazene | % | | | 14.2 | 14.2 | 8.5 | 8.5 | 8.5 |
| FR | | | | | | | | |
| Regular SBS | % | 2.5 | 2.5 | 2.5 | 2.5 | 2.5 | 2.5 | |
| rubber | | | | | | | | |
| ZnO | % | 0.1 | 0.1 | 0.1 | 0.1 | 0.1 | 0.1 | 0.1 |
| ZnS | % | 0.1 | 0.1 | 0.1 | 0.1 | 0.1 | 0.1 | 0.1 |
| PPO 803 | % | 50 | | 52.1 | | 57.8 | | |
| Tris(di-t- | % | 0.5 | 0.5 | 0.5 | 0.5 | 0.5 | 0.5 | 0.5 |
| butylphenyl) | | | | | | | | |
| phosphite | | | | | | | | |
| PTFE | % | 0.05 | 0.05 | 0.05 | 0.05 | 0.05 | 0.05 | 0.05 |
| PE (ld), | % | 1.5 | 1.5 | 1.5 | 1.5 | 1.5 | 1.5 | 1.5 |
| milled 1000 | | | | | | | | |
| microns | | | | | | | | |
| PPO- | % | | 50 | | 52.1 | | 57.8 | 60.3 |
| Siloxane | | | | | | | | |
| copolymer | | | | | | | | |
| HIPS | % | 27.8 | 27.8 | 28.9 | 28.9 | 28.9 | 28.9 | 28.9 |
| regular | | | | | | | | |
| RDP | % | 17.5 | 17.5 | | | | | |
| Total | | 100 | 100 | | 100 | 100 | 100 | 100 |

TABLE 6

| | Unit of | |
|---|---|---|
| Parameters | Measure | Settings |
| Compounder Type | none | 28 mm diameter ZSK |
| | | twin-screw extruder |
| Barrel Size | mm | 28 mm |
| Die | holes | 2 |
| Zone 0 Temp (feed | ° C. | 40 |
| Zone) | | |
| Zone 1 Temp | ° C. | 170-180 |
| Zone 2 Temp | ° C. | 220-235 |
| Zone 3 Temp | ° C. | 260 |
| Zone 4 Temp | ° C. | 260 |
| Zone 5 Temp | ° C. | 270 |
| Zone 6 Temp | ° C. | 270 |
| Zone 7 Temp | ° C. | 270 |
| Zone 8 Temp | ° C. | 180 |
| Die Temp | ° C. | 280 |
| Screw speed | rpm | 300 |
| Throughput | kg/hr | 12-16 |
| Vacuum | MPa | 0.7 |

The polyphenylene ether-polysiloxane copolymer, the polystyrene, the impact modifier and the phenoxyphosphazene were fed from main throat from upper stream. All additives (mold release agent, antioxidants, and the like) were pre-blended with the polyphenylene ether powder in a super blender and then fed into the extruder. The molding conditions are detailed in the Table 7.

TABLE 7

| | Unit | |
|---|---|---|
| Parameter | of Measure | Settings |
| Pre-drying time | Hour | 2 |
| Pre-drying temp | ° C. | 80 |
| Hopper temp | ° C. | 60 |
| Zone 1 temp | ° C. | 220-240 |
| Zone 2 temp | ° C. | 240-260 |
| Zone 3 temp | ° C. | 260-280 |
| Nozzle temp | ° C. | 240-260 |
| Mold temp | ° C. | 60 |
| Screw speed | rpm | 30 |
| Back pressure | bar | 5 |
| Cooling time | s | 20 |
| Molding Machine | NONE | Engel ES500 75 or 80 or 110 ton |
| Shot volume | mm | 63 |
| Injection speed (mm/s) | mm/s | 30 |
| Holding pressure | bar | 45-55 |
| Max. Injection pressure | bar | 63-83 |

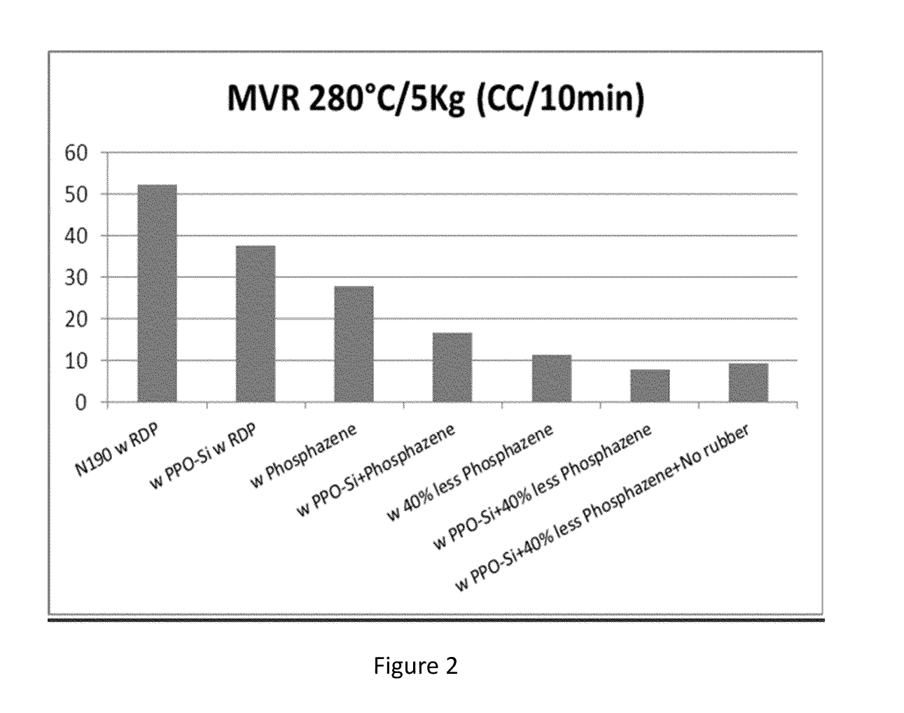

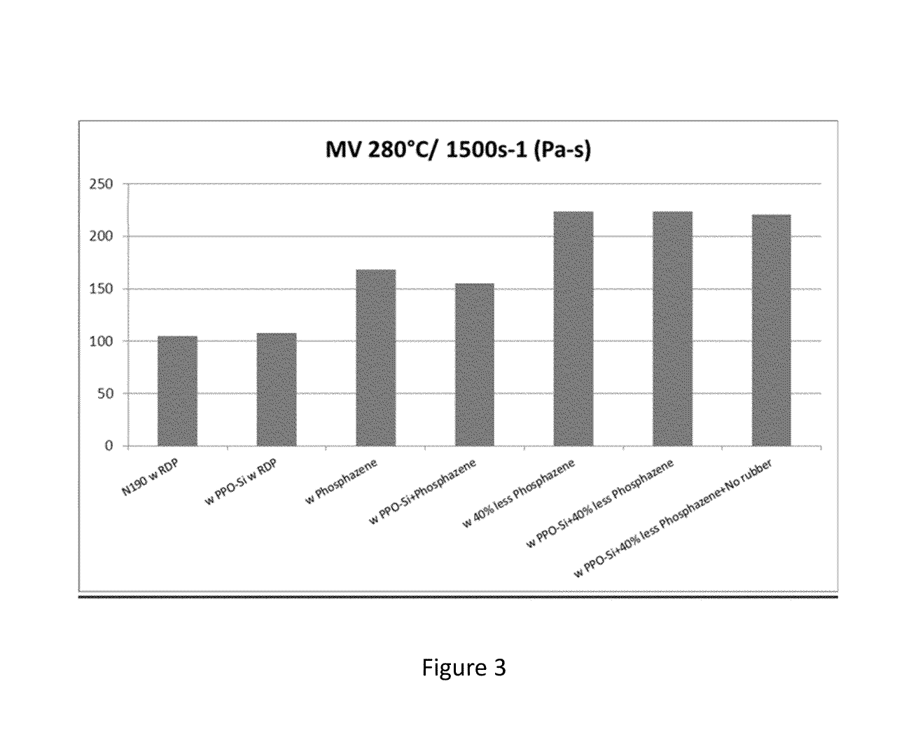

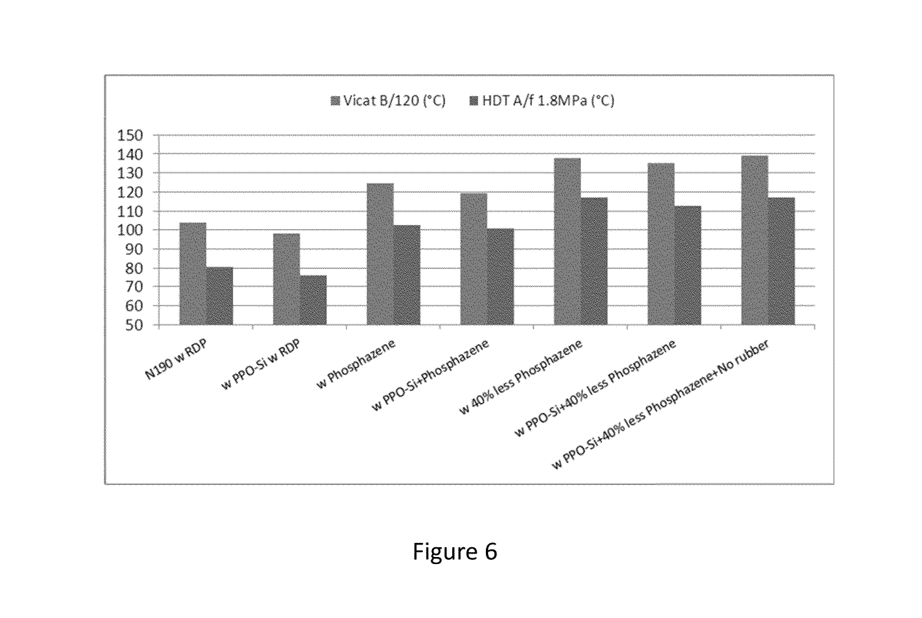

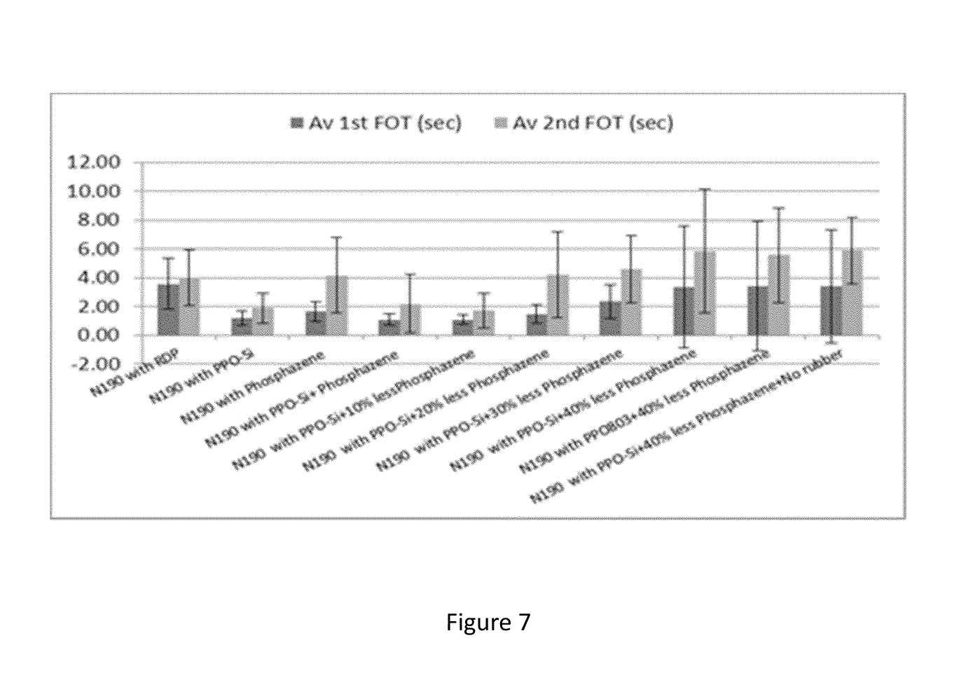

The properties for the various compositions (EXP 1-7) of the Table 5 are shown in the Tables 8 and 9. Tables 8 and 9 along with FIGS. 2-7 show the properties for the samples (EXP 1-7) of Table 5.

TABLE 8

| | | | | | | | EXP 7 | |
|---|---|---|---|---|---|---|---|---|
| | | EXP 2 | | | | EXP 6 | N190 with | EXP 8 |
| | EXP 1 | N190 | | EXP 4 | EXP 5 | N190 with | PPO-Si + 40% | N190 with |
| | N190 | with | EXP 3 | N190 with | N190 with | PPO-Si + 40% | less | PPO-Si + |
| Property | with | PPO- | N190 with | PPO-Si + | 40% | less | Phosphazene + | 30% less |
| Comparison | RDP | Si | Phosphazene | Phosphazene | Phosphazene | Phosphazene | No rubber | Phosphazene |
| MVR | 52 | 37 | 28 | 17 | 11 | 8 | 9 | 9 |
| 280° C./5 kg | | | | | | | | |
| (cc/10 min) | | | | | | | | |
| MV | 105 | 108 | 168 | 155 | 223 | 223 | 221 | 203 |
| 280° C./1500 s⁻¹ | | | | | | | | |
| (Pa-s) | | | | | | | | |
| Izod | 14 | 26 | 24 | 36 | 22 | 34 | 26 | 34 |
| Notched | | | | | | | | |
| Impact @ | | | | | | | | |
| RT (kJ/m²) | | | | | | | | |
| Charpy | 16 | 22 | 29 | 38 | 23 | 33 | 26 | 35 |
| notched | | | | | | | | |
| Impact: | | | | | | | | |
| 23° C. 7.2 J | | | | | | | | |
| (kJ/m2) | | | | | | | | |
| MAI | 18 | 72 | 90 | 97 | 84 | 91 | 92 | 97 |
| puncture | | | | | | | | |
| Energy, | | | | | | | | |
| 44 m/s (J) | | | | | | | | |
| Vicat B/120 | 104 | 98 | 124 | 114 | 138 | 135 | 139 | 130 |
| (° C.) | | | | | | | | |
| HDT 1.8 | 80 | 76 | 103 | 101 | 117 | 113 | 117 | 111 |
| MPa (° C.) | | | | | | | | |
| Tensile | 2347 | 2182 | 2158 | 2058 | 2213 | 2119 | 2224 | 2084 |
| Modulus | | | | | | | | |
| (MPa) | | | | | | | | |
| Tensile | 56 | 49 | 56 | 50 | 58 | 54 | 59 | 53 |
| Strength @ | | | | | | | | |
| Yield (MPa) | | | | | | | | |
| Nominal | 16 | 15 | 20 | 23 | 19 | 16 | 11 | 19 |
| strain @ | | | | | | | | |
| break (%) | | | | | | | | |
| Flexural | 2351 | 2081 | 2159 | 2021 | 2186 | 1993 | 2282 | 1954 |
| Modulus | | | | | | | | |
| (MPa) | | | | | | | | |
| Flexural | 84 | 73 | 84 | 76 | 86 | 80 | 91 | 78 |
| Strength | | | | | | | | |
| (MPa) | | | | | | | | |

TABLE 9

| | | | | | | EXP 6 | EXP 7 | EXP 8 |
|---|---|---|---|---|---|---|---|---|
| | EXP 1 | EXP 2 | | EXP 4 | EXP 5 | N190 with | N190 with PPO- | N190 with |
| | N190 | N190 | EXP 3 | N190 with | N190 with | PPO- | Si + 40% less | PPO-Si + 30% |
| | with | with | N190 with | PPO-Si + | 40% less | Si + 40% less | Phosphazene + | less |
| Flammability | RDP | PPO-Si | Phosphazene | Phosphazene | Phosphazene | Phosphazene | No rubber | Phosphazene |
| Av 1^{st} FOT (sec) | 3.58 | 1.17 | 1.66 | 1.08 | 3.40 | 3.36 | 3.39 | 2.34 |
| Std Dev 1^{st} FOT | 1.76 | 0.48 | 0.70 | 0.39 | 4.51 | 4.21 | 3.93 | 1.16 |
| Av 2^{nd} FOT (sec) | 4.02 | 1.89 | 4.17 | 2.20 | 5.56 | 5.86 | 5.88 | 4.59 |
| Std Dev 2^{nd} FOT | 1.93 | 1.07 | 2.65 | 2.02 | 3.28 | 4.31 | 2.28 | 2.32 |
| p(FTP) V-0@1.5 mm | 0.86 | 1.00 | 0.87 | 0.99 | 0.30 | 0.44 | 0.55 | 0.76 |
| p(FTP)V-1@1.5 mm | 1.00 | 1.00 | 0.99 | 0.99 | 0.98 | 0.99 | 0.99 | 0.99 |
| p(FTP)V-0@1.0 mm | | 0.97 | 0.59 | | 0.4 | 0.04 | | |
| P(FTP)V-1@1.0 mm | | 0.99 | 0.99 | | 0.99 | 0.94 | | |

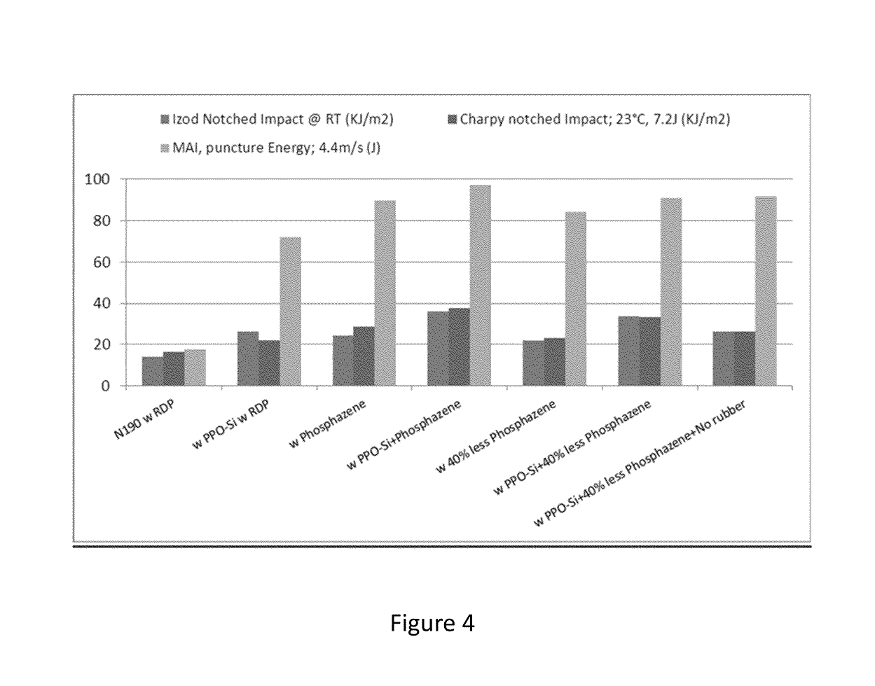

It is observed that use of phenoxyphosphazene compound and/or the polyphenylene ether-polysiloxane copolymer shows a significantly higher impact strength at room temperature as shown in Table 8, FIG. 4 (EXP 2-8) when compared to the polyphenylene ether samples that contain resorcinol di-phosphate (control example) (EXP 1). The combination of polyphenylene ether-polysiloxane copolymer with the phenoxyphosphazene compound results in the best impact properties. (See EXP 4 vs. EXP 1, 2 and 3.) Even for the formulations containing 40% lower phenoxyphosphazene compound loading, high impact values are observed. (See EXP 5 vs. 1; EXP 6 vs. 2; and EXP 6 vs. 5.)

Blends containing the polyphenylene ether-polysiloxane copolymer in combination with phenoxyphosphazene compounds display high impact properties (Charpy and multiaxial) (EXP 4, 6-8) even with a reduced amount of impact modifier (EXP 7) when compared to control blends (EXP 1 and 2) or the corresponding polyphenylene ether based formulation (EXP 5).

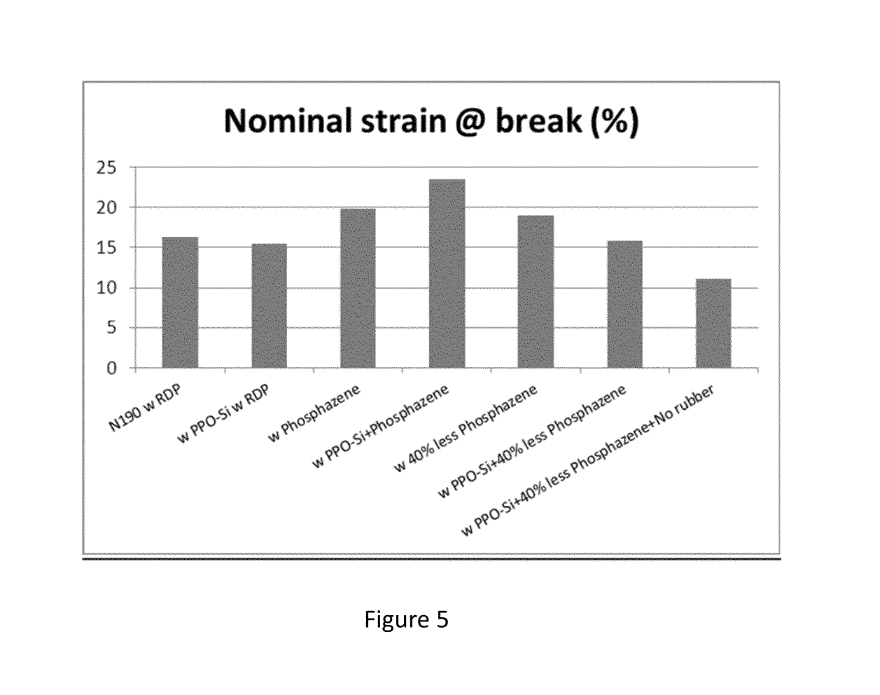

It has also been observed that use of the phenoxyphosphazene compound shows significantly higher nominal strain at break values as shown in Table 8 and FIG. 5 (EXP 3 and 4) when compared to polyphenylene ether or polyphenylene ether-polysiloxane copolymer based controls (EXP 1 and 2). The combination of polyphenylene ether-polysiloxane copolymer with phenoxyphosphazene compound resulted in the highest nominal strain at break value property (EXP 4 vs. EXP 1, 2 & 3). Even for the formulations containing 40 wt % lower phenoxyphosphazene compound loading, higher or equivalent nominal strain at break values were observed (EXP 5 vs. 1; EXP 6 vs. 2 or EXP 6 vs. 5). Removing the impact modifier together with 40% lower phenoxyphosphazene compound loading yielded the lowest nominal strain at break value (EXP 7). Compositions containing 40% lower Phosphazene FR show comparable flammability UL-94 V1@ 1.5 and 1.0 mm when compared to control (EXP 1 vs. 5 and EXP 2 vs. 6) although the V0@1.0 mm performance is less good. There appears to be an optimum UL-94 V-0@1.0 mm flammability performance with 30% less phosphazene (EXP 8).

The composition disclosed herein may be advantageously used to manufacture a variety of different articles such as computer housings, housings for electronic goods such as televisions, cell phones, tablet computers, automotive parts such as interior body panels, parts for aircraft, and the like.

It is to be noted that all ranges detailed herein include the endpoints. Numerical values from different ranges are combinable.

The transition term comprising encompasses the transition terms “consisting of and “consisting essentially of.”

The term “and/or” includes both “and” as well as “or.” For example, “A and/or B” is interpreted to be A, B, or A and B.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed:

1. A flame retardant composition comprising:
a polyphenylene ether-polysiloxane copolymer or a combination comprising a polyphenylene ether-polysiloxane copolymer and a polyphenylene ether;
an impact modifier; and
a phosphazene compound.

2. The composition of claim 1, where the phosphazene compound is present in an amount of about 1 to about 20 wt %, based on a total weight of the flame retardant composition.

3. The composition of claim 1, where the phosphazene compound has the structure of formula (11) below: 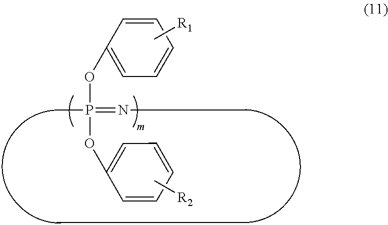
where in the formula (11), m represents an integer of about 3 to about 25, R₁ and R₂ are the same or different and are independently a hydrogen, a halogen, a C₁₋₁₂ alkoxy, or a C₁₋₁₂ alkyl.

4. The composition of claim 1, where the phosphazene compound is phenoxy cyclotriphosphazene, octaphenoxy cyclotetraphosphazene, decaphenoxy cyclopentaphosphazene, or a combination comprising at least one of the foregoing phosphazene compounds.

5. The composition of claim 1, where the phosphazene compound has the structure of formula (12) 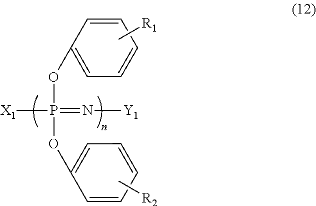
where in the formula (12), X¹ represents a —N═P(OPh)₃ group or a —N═P(O)OPh group, Y¹ represents a —P(OPh)₄ group or a —P(O) (OPh)₂ group, n represents an integer from 3 to 10000, Ph represents a phenyl group, R1 and R2 are the same or different and are independently a hydrogen, a halogen, a C₁₋₁₂ alkoxy, or a C₁₋₁₂ alkyl.

6. The composition of claim 1, where the phosphazene compound is a crosslinked phenoxyphosphazene.

7. The composition of claim 1, further comprising an antidrip agent.

8. The composition of claim 1, where the composition has a flame retardancy of V-0 at a thickness of 1.5 millimeter or lower when measured as per a UL-94 protocol.

9. The composition of claim 1, where the composition has a flame retardancy of V-0 at a thickness of 0.4 millimeter or lower when measured as per a UL-94 protocol.

10. The composition of claim 1, where the composition has a flame retardancy of V-0 at a thickness of 0.8 millimeter or lower when measured as per a UL-94 protocol.

11. The composition of claim 1, where the composition has a flame retardancy of V-0 at a thickness of 1.2 millimeter or lower when measured as per a UL-94 protocol.

12. The composition of claim 1, where the composition has a flame retardancy of V-0 at a thickness of 3.0 millimeter or lower when measured as per a UL-94 protocol.

13. The composition of claim 1, where the composition does not contain a flame retardant other than the phosphazene compound.

14. The composition of claim 1, where the flame retardant composition comprises about 3 to about 30 wt % of the impact modifier, based on the total weight of the flame retardant composition.

15. The composition of claim 1, where the flame retardant composition further comprises polystyrene in an amount of 10 to 40 weight percent, based on the total weight of the composition.

16. The composition of claim 1, where the composition has a flame retardancy of V-0 at a thickness of less than or equal to about 3.0 mm when measured as per UL-94 and a notched Izod impact strength of greater than or equal to about 22 kilojoules per meter square when measured as per ISO 180/1A.

17. The composition of claim 1, where the polyphenylene ether-polysiloxane copolymer is present in an amount of 40 to 70 weight percent, based on the total amount of the flame retardant composition.

18. The composition of claim 1, further comprising rubber-modified polystyrene in an amount of 3 to 40 weight percent, based on the total amount of the flame retardant composition.

19. A method comprising:
blending a polyphenylene ether-polysiloxane copolymer or a combination comprising comprising a polyphenylene ether-polysiloxane copolymer and a polyphenylene ether; an impact modifier; and a phenoxyphosphazene compound.

20. The method of claim 19, further comprising blending an antidrip agent.

21. The method of claim 19, further comprising molding the flame retardant composition.

22. An article manufactured from the composition of claim 1.
